(19) United States
(12) Patent Application Publication
(10) Pub. No.: US 2008/0155740 A1
(43) Pub. Date: Jul. 3, 2008

(54) Bidet assembly for toilets

(76) Inventor: William Cheng Uy, Antioch, CA (US)

Correspondence Address: WILLIAM CHENG UY, 5297 JUDSONVILLE DRIVE, ANTIOCH, CA, 94531, US

(21) Appl. No.: 11/880,383

(22) Filed: Jul. 20, 2007

Related U.S. Application Data
(63) Continuation-in-part of application No. 11/731,862, filed on Apr. 2, 2007.
Application No. 11/731,862 is a continuation-in-part of application No. 11/648,878, filed on Jan. 3, 2007.

(51) Int. Cl. A61H 35/00

(52) U.S. Cl. 4/448

(57) ABSTRACT

A bidet assembly comprises at least one jet nozzle, connected to a multi-port tube fitting, which is connected to a water supply tube, which may comprise of four sections, and which is connected to the toilet bowl refill nipple, and a non-permanent mounting means. Said bidet assembly is a one-size-fits-all for retrofitting toilets of all sizes and shapes, has no moving parts, valves or controls and which provides fine jet streams of cool water spray—even from chilly cold water source—for use in cleansing a user's private parts during a toilet tank refill cycle. Said bidet assembly is mounted inside and behind a toilet tank and inside a bowl and, therefore, is completely hidden from view and keeps water from splashing outside of the bowl. Said bidet assembly can be mounted or removed without tools, in less than two minutes and leaves neither mars nor damage on a toilet.

### RELATED APPLICATIONS

This application is a Continuation-In-Part of application Ser. No. 11/731,862, filed on Apr. 2, 2007, which is a Continuation-In-Part of application Ser. No. 11/648,878, filed on Jan. 3, 2007.

### REFERENCES CITED

U.S. PATENT DOCUMENTS

| | | | |
|---|---|---|---|
| 3,256,531 | June 1966 | Arensberg | 4/448 |
| 3,310,813 | May 1967 | Johnson | 4/448 |
| 3,943,961 | September 1976 | Knapp | 4/420.4 |
| 4,242,764 | January 1981 | Fukuda | 4/420.4 |
| 4,450,596 | May 1984 | Cohen | 4/447 |
| 4,691,391 | September 1987 | Kuo | 4/447 |
| 5,142,711 | September 1992 | Parikh | 4/420.4 |
| 5,247,711 | September 1993 | Kwon | 4/420.4 |
| 5,271,104 | December 1993 | LaTora | 4/420.4 |
| 5,287,566 | February 1994 | Azada | 4/420.4 |
| 5,652,971 | August 1997 | Wokas | 4/420.4 |
| 5,722,097 | February 1998 | Deveer | 4/420.4 |
| 5,799,341 | September 1998 | Rodas | 4/420.4 |
| 5,809,585 | September 1998 | Farshad | 4/443 |
| 5,953,766 | September 1999 | Szoke | 4/420.4 |
| 5,991,937 | November 1999 | Safara | 4/420.4 |
| 6,000,070 | December 1999 | Bonin | 4/349 |
| 6,178,568 | January 2001 | Boulieris | 4/420.4 |
| 6,321,396 | November 2001 | Vallejo | 4/420.4 |
| 6,339,852 | January 2002 | Huang | 4/420.4 |
| 6,408,451 | June 2002 | Carn et al. | 4/420.4 |
| 6,473,913 | November 2002 | Bell | 4/448 |
| 6,526,602 | March 2003 | Jeon | 4/420.4 |
| 6,643,856 | November 2003 | Valverde | 4/420.4 |
| 6,704,946 | March 2004 | Mueller et al. | 4/420.4 |
| 6,785,915 | September 2004 | Daugherty | 4/448 |
| 6,843,432 | January 2005 | Philpott | 239/289 |
| 6,874,173 | April 2005 | Smith et al. | 4/420.4 |
| 6,978,492 | December 2005 | Francisco et al. | 4/420.4 |

### FEDERALLY SPONSORED RESEARCH OR DEVELOPMENT

Not Applicable.

### SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates to a bidet assembly for retrofitting toilets for the cleansing of a user's private parts.

2. Descriptions of the Prior Art

Bidet is a stand-alone unit beside a conventional toilet to provide spray of water to the underside of a user for the cleansing of the user's private parts. Because bidet requires additional floor space and is also expensive, they are not installed in most homes.

Therefore, retrofitting existing conventional toilets with a bidet assembly provides a practical solution. There is a myriad of prior art on the design of an ideal bidet assembly. All of the prior art bidet attachments, however, suffer at least one of the following deficiencies: prone to splash water out of toilet, expensive to manufacture, complex, permanent attachments, difficult to install and remove, leave mar or damage in toilet when bidet is removed, difficult to use, failure to meet sanitary requirements, and unsightly. Examples of such prior art bidet attachments are shown and described in the cited References.

A major problem that is not obvious from reading the prior art and because it was not specifically addressed nor pointed out by the prior art is the propensity of splashing water out of a toilet bowl during the application of prior art devices. As a user sits on a toilet seat, it is difficult to maneuver a hand-held device, such as a hand-held sprayer (U.S. Pat. Nos. 6,978,492, 6,843,432, 6,785,915, 6,704,946, 6,473,913, 5,991,937, 5,953,766, 5,809,585), into and out of an opening, which is behind the user and between the user's buttocks and toilet seat, with water continuously jetting out of the sprayer, and preventing water from spraying outside of a toilet.

The process becomes more complicated when it also requires the manipulation of a handle, valve, knob or other controls. It becomes further more complicated, and may even be confusing, when a user gets up in the middle of the night, perhaps half asleep and in the dark, goes to the toilet and attempts to use such devices. It becomes even further more difficult when such devices (U.S. Pat. Nos. 5,287,566, 5,722,097, 5,799,341) are located behind the user.

The prior art bidet device of U.S. Pat. No. 3,310,813 presented an unsanitary condition because its vertical spray nozzle is directly under the buttocks of a user. U.S. Pat. No. 6,000,070 described a bidet toilet ensemble with the bidet spray head, though not directly under a user's buttock, at the toilet bowl's water line and, therefore, is easily subject to contamination by feces. Although this problem is solved by U.S. Pat. No. 5,722,907, it requires manipulating a handle behind the user to move the bidet structure out of the way. U.S. Pat. No. 5,271,104 solved said problem using a pivotal nozzle. This is not a problem for this present invention of a bidet assembly because said bidet assembly is designed to be hidden from view and, therefore, its nozzle is not directly under a user buttocks.

The prior art bidet attachments of U.S. Pat. Nos. 5,799,341, 5,271,104, 5,142,711 are among the easier ones to install as far as the water supply source is concern, because they connect to the toilet bowl's refill water outlet nipple as their water supply source, instead of the main water supply pipe to the toilet tank. However, these prior art bidets are still expensive (U.S. Pat. No. 5,271,104), difficult to use (U.S. Pat. No. 5,799,341), and unsightly (for all three said patents). All of those patents require some permanent attaching means, such as adhesives, screws or bolts and nuts, to secure the spray nozzles.

U.S. Pat. No. 5,142,711 additionally specified securing spray nozzles on a toilet bowl uppermost surface. Such nozzles placement location presents two problems: First, said nozzles prevent some toilet seats from mating completely on the toilet bowl surface; Second, water shooting out from the jet spray nozzle would easily spray outside a toilet bowl. Therefore, its stand alone claim 1 is not a practical and viable solution. This prior art attempted to solve said problem by diverting part of the water (claim 3) to the overflow tube using a “T” fitting. However, this partial diversion of water is still insufficient to solve said problem. Further attempt (claim 8) was made by this prior art to solve said problem by specifying “a means, such as an adjustable clamp, for restricting the flow of water.” A close/open clamp, as shown by this prior art, does not provide a good control for flow of water. A valve would have given better result. In any case, by adding a means of control complicates the device ease of use.

The prior art bidet attachment of U.S. Pat. No. 3,256,531 specified an integral liquid supply and nozzle tube system wherein part of the liquid supply tube having two resilient attachment means, one of said means is a C-shaped clip conforming substantially to the cross-section of a toilet bowl top rim. Said design is specific to a rim geometry and is impractical for general application as there is a myriad of sizes and shapes for a bowl top rim. Other parts of the bidet attachment are located on top and also protruding out the side of a toilet bowl and are, therefore, unsightly. This prior art is also incomplete as a complete bidet system as it only mentioned a pressurized liquid source without specifying what that source would be and it also mentioned that a valve may be necessary as a means for controlling the liquid flow.

All prior art bidet devices are unsightly because they are seen as clutter in a limited space toilet room, or can be seen as add-on on the side of a toilet or protruding out of a toilet in many places.

To avoid unsightliness, bidet assembly parts must be out-of-sight and that would require bidet parts to be located within the confines of a toilet tank and bowl. This is a stringent requirement because there are no standards in the size and shape for toilet tank and bowl. And because there are no standards—other than the bolt down holes spacing for the toilet and the hole spacing for bolting a toilet seat—there are literally a myriad of toilet sizes and shapes in the market. Making and inventorying a myriad of bidet sizes is impractical and expensive. The only standard for toilet bowl is the name for the shape of a bowl—round and elongated. The standardization, however, ended there. Within each round and elongated classification, there are again myriad of sizes and shapes. Differences in size and shape are found not only among different brands but also within a brand. For example, one company alone has 36 different models and each model's size and shape are different.

The following table shows actual measurements of toilet sizes (in inches) for one brand alone for some of its models. The letters represent parts of a toilet tank and bowl shown in FIG. 1 and FIG. 2.

| | | | | | | | TANK DI- | |
|---|---|---|---|---|---|---|---|---|
| | BOWL DIMENSIONS | | | | | | MENSIONS | |
| BOWL SHAPE | L | W | LW | LD | LH | D | TH | TL |
| ROUND | 11.50 | 10.63 | 3.00 | 1.13 | 1.50 | 3.75 | 7.00 | 17.00 |
| ROUND | 12.00 | 11.00 | 2.25 | 1.00 | 1.50 | 4.38 | 12.00 | 17.50 |
| ELONGATED | 13.50 | 10.75 | 2.50 | 1.50 | 1.50 | 4.25 | 10.25 | 16.00 |
| ELONGATED | 13.50 | 10.88 | 2.75 | 1.25 | 1.50 | 4.75 | 10.25 | 15.50 |
| ELONGATED | 13.63 | 10.88 | 2.75 | 1.25 | 1.50 | 4.50 | 10.50 | 16.00 |
| ELONGATED | 14.00 | 10.75 | 2.25 | 1.00 | 1.75 | 5.00 | 12.00 | 17.00 |
| ELONGATED | 14.00 | 11.00 | 2.50 | 1.00 | 1.50 | 5.75 | 15.25 | |
| ELONGATED | 14.00 | 11.00 | 2.50 | 1.00 | 1.75 | 5.00 | 14.50 | |
| ELONGATED | 14.00 | 11.00 | 2.50 | 1.00 | 1.88 | 5.00 | 12.13 | 17.00 |
| ELONGATED | 14.38 | 11.50 | 2.25 | 1.50 | 1.50 | 5.00 | 15.25 | 16.75 |
| ELONGATED | 15.25 | 10.38 | 1.50 | 0.88 | 1.50 | * | * | * |
| ELONGATED | 15.25 | 11.75 | 1.50 | 1.00 | 1.63 | 4.25 | 12.25 | |

* NOT APPLICABLE - ONE PIECE UNIT

Unusual shape differences among models further contributed to the complexity. For examples: 1. Some toilets have a bulge at the front end of the toilet bowl and, therefore, have a zero value for FLD. 2. Some toilets are one piece unit, that is, the toilet tank and bowl are not separate units.

It can be concluded from this myriad of sizes and shapes that designing a one-size bidet assembly—that will fit within the confines of any toilet—presents a major challenge to innovation. This may well be the reason why all prior art bidet devices retrofit outside the confines of a toilet tank and bowl.

The uncomfortable feeling of chilly cold water on a user's skin is addressed in U.S. Pat. Nos. 6,843,432, 6,643,856, 6,178,568, 5,953,766, 5,809,585, 5,271,104, 4,242,764, and 4,691,391 by either mixing a hot water source with cold water or passing cold water through a special heater. Having a hot water source next to a toilet, however, is not common. Installing a special heater adds further to the expense and complexity of a bidet assembly.

In the present invention of a bidet assembly, all of the above said problems and deficiencies are successfully solved.

### SUMMARY OF THE INVENTION

The present invention provides a bidet assembly for retrofitting toilets of all sizes and shapes to provide clean fine jet stream of water for the cleansing of a user's private parts while keeping water from splashing out of a toilet bowl without the use of any controlling devices. The bidet assembly of this invention comprises a nozzle connected to a water supply tube and a non-permanent mounting means for holding said nozzle inside a toilet bowl, at the bowl's lip vertical surface or under the bowl's lip horizontal surface. Said strategic placement of said nozzle keeps the jet stream of water within the bowl inner chamber and prevents water from splashing out. The bidet assembly of this invention is easily installed within the confines of a toilet tank and bowl, with most or all of its parts not visible, therefore it is not unsightly.

The bidet assembly of this invention may also have multiple nozzles by attaching one or more multi-port tube fitting to said water supply tube. There can be as many nozzles as there are available ports. For example, one “T” tube fitting, which has 3 ports, can have two connected nozzles.

One embodiment example of said non-permanent mounting means is a “C” clamp that holds said water supply tube and the connected end of said nozzle on the underside of a bowl's lip. Another embodiment example of said non-permanent mounting means is a long and stiff member with a spring-back property that wedges itself and one end of said water supply tube and nozzle assembly against a toilet bowl's inside curve surface and below the bowl's lip underside. Said long and stiff member is first bent to pass through a the bowl's opening and then released. Said long and stiff member, due to its spring-back property, tends to straighten out but is restrained by the bowl inside surfaces. Therefore, the tension within said restrained long and stiff member holds the member wedged against the bowl inside surfaces.

Another embodiment example of said non-permanent mounting means is making a small porthole on the bowl's lip and said tube nozzle is inserted through the porthole into the confines of the toilet bowl water flushing channel. The end of the tube nozzle being wedged snugly in the porthole.

A further embodiment of the present invention is that said water supply tube being directly connected to the bowl refill nipple on the ballcock so that clean water for cleansing is provided as the toilet is being flushed and the bowl is being refilled with water through said bidet assembly of this invention.

A further preferred embodiment of the present invention is that said non-permanent mounting means, said water supply tube and said nozzle is one integral unit formed from a single tube.

A further preferred embodiment of the present invention is that said non-permanent mounting means, said water supply tube and said nozzle is one integral unit joined together by at least one fitting.

A still further preferred embodiment of the present invention is that at least one nozzle is provided through the use of multi-port fitting or jointed fittings. Therefore, if the singular word of nozzle is used in this Specification, it should not be construed that only one nozzle can be used.

A still further preferred embodiment of the present invention is that said nozzle is selected from the list of tubing, bent tubing, straight fitting, elbow fitting and 90° elbow flexible tube fitting.

A still further preferred embodiment of the present invention is to provide fine jet spray of water, which has the effects of a pleasurable cool sensation rather than the shock of an onslaught of uncomfortable freezing cold sensation. This is accomplished without the use of a hot water source or a heater.

An objective of the present invention is to provide a bidet assembly that is inexpensive to manufacture.

A further objective of the present invention is to provide a bidet assembly that can be manufactured using commonly available merchandise.

A further objective of the present invention is to provide a bidet assembly that is capable of retrofitting all size and shape of toilets. A one size fits all.

A still further objective of the present invention is to provide a bidet assembly that is simple, quick and easy to install and remove and without the need to remove the toilet seat during installation or removal.

A still further objective of the present invention is to provide a bidet assembly that does not mar nor damage a toilet.

A still further objective of the present invention is to provide a bidet assembly that does not cause water to splash out of a toilet bowl through the strategic placement of water spray nozzle with adjustable spray angle.

A still further objective of the present invention is to provide a bidet assembly that has no valve, handle, and control to manipulate and, therefore, is easy to use.

A still further objective of the present invention is to provide a bidet assembly that is hidden within the confines of a toilet tank, bowl and seat and, therefore, not unsightly.

A still further objective of the present invention is to provide a bidet assembly that fulfills sanitary requirements and which is not vertically under the opening of a toilet seat and, therefore, not under a user's buttock, and therefore, can not be soiled by the user.

The present invention of a bidet assembly is particularly noteworthy in providing an inexpensive bidet assembly that a user can install or remove quickly and easily, that is hidden from view, that provides cool clean water to the user for cleansing private parts by just simply flushing a toilet without manipulating any controls, that can retrofit all toilet sizes and shapes, that meets sanitary requirements, and that does not cause water to splash out of a toilet.

The various features and benefits which characterize the present invention of a bidet assembly will become apparent with those skilled in the art after reading the following description of drawings and detailed description of the present invention.

### BRIEF DESCRIPTION OF THE DRAWINGS

FIG. 1 is a top view of a conventional toilet, without its cover, seat, tank cover and tank contents, wherein the dimension of parts is referenced by letters.

FIG. 2 is a cross-sectional view of the toilet in FIG. 1 wherein the dimension of parts is also referenced by letters.

FIG. 3 is a perspective view of a conventional toilet, without its cover, seat and tank cover, wherein parts referred to in this invention are identified.

FIG. 4 is the same cross-sectional view as FIG. 2 wherein parts referred to in this invention are identified.

FIG. 5 is a top view of a conventional toilet similar to FIG. 1 wherein the hidden elliptical profile of part 7, in broken line, has been added.

FIG. 6 is a perspective view of a basic “C” clamp mounting means.

FIG. 7 is a perspective view of a threaded rod “C” clamp mounting means.

FIG. 8 is a perspective view of a spring-loaded “C” clamp mounting means.

FIG. 9 is a rear view of the spring-loaded “C” clamp of FIG. 8 showing the location of the spring.

FIG. 10 is a perspective view of a basic “C” clamp bidet assembly of this invention, as installed in a toilet, which is shown as a vertical cross-section taken along the line 10-10 of a conventional toilet shown in FIG. 3 and view at an oblique angle in the direction of the arrows.

FIG. 11 is a perspective view of a tube with a flare end.

FIG. 12 is a top front view of an integral “C” clamp bidet assembly of this invention wherein the water supply portion and the nozzle are on the same dimensional plane.

FIG. 13 is a perspective view of an integral “C” clamp bidet assembly of this invention, shown in FIG. 12.

FIG. 14 is a perspective view showing an embodiment example of said integral “C” clamp bidet assembly, as installed in a toilet, which is shown as a vertical cross-section and view at an oblique angle.

FIG. 15 is a top front view of an integral “C” clamp bidet assembly of this invention wherein the water supply portion and the nozzle are on different dimensional planes.

FIG. 16 is a perspective view of an integral “C” clamp bidet assembly of this invention, shown in FIG. 15.

FIG. 17 is a perspective view showing an embodiment example of said integral “C” clamp bidet assembly, as installed in a toilet, which is shown as a vertical cross-section and view at an oblique angle.

FIG. 18 is a perspective view showing an embodiment example of a bidet assembly of this invention featuring a long and stiff member with spring-back property mounting means, as installed in a toilet, which is shown as a vertical cross-section and view at an oblique angle.

FIG. 19 is a graph on x-y axes with a formula for calculating the % spring-back for a long and stiff member.

FIG. 20 is a perspective view of an integral long and stiff member bidet assembly of this invention formed from a single tube.

FIG. 21 is a perspective view showing an embodiment example of said integral long and stiff member bidet assembly of FIG. 20, as installed in a toilet, which is shown as a vertical cross-section and view at an oblique angle.

FIG. 22 is a perspective view of an example of a four-port fitting for a multi-port fitting of this invention.

FIG. 23 is a perspective view of an example of a two-jointed “T” tube fitting to provide for a four-port fitting of this invention and showing the rotation of the fittings on two dimensional planes.

FIG. 24 is a perspective view of another embodiment of an integral long and stiff member bidet assembly of this invention using said two-jointed “T” tube fitting of FIG. 23 and having one tube nozzle. Said long and stiff member comprises of two lengths of tubing 61 and 62 joined together by said jointed “T” tube fitting.

FIG. 25 is a top front view of said bidet assembly shown in FIG. 24.

FIG. 26 is a perspective view of another embodiment of an integral long and stiff member bidet assembly of this invention using said two-jointed “T” tube fitting of FIG. 23 and having two tube nozzles.

FIG. 27 is a top front view of said bidet assembly shown in FIG. 26.

FIG. 28 is perspective view showing an embodiment example of the integral long and stiff member bidet assembly with one tube nozzle of FIGS. 24 and 25, as installed in a toilet, which is shown as a vertical cross-section and view at an oblique angle.

FIG. 29 is perspective view showing an embodiment example of the integral long and slender member bidet assembly with two tube nozzles of FIGS. 26 and 27, as installed in a toilet, which is shown as a vertical cross-section and view at an oblique angle.

FIG. 30 is a perspective view showing an embodiment example of a bidet assembly wherein said water supply tube is connected to a “T” tube fitting having three ports to provide for two tube nozzles.

FIG. 31 is a perspective view showing an embodiment example of a “C” clamp bidet assembly wherein said “C” clamp and water supply tube are one integral tubing unit. The bottom end of said tubing unit is connected to a “T” fitting with three ports to provide for two tube nozzles.

FIG. 32 shows two ellipses representing the elliptical shape of an actual toilet bowl opening 3 (smaller elliptical shape) and the bowl's lip underside rear corner edge 7 (larger elliptical shape), shown in FIG. 5. Part 75 represents a long and stiff member bent into a “U” shape in order to pass through the toilet bowl opening 3. Thereafter, said bent long and stiff member is released in the larger opening of rear corner edge 7 and, like a spring, the “U” shape opens up wider to become part 76.

FIG. 33 is a perspective view showing an embodiment example of a bidet assembly wherein one end of said water supply tube has a “Z” shape bent before connecting to a “T” tube fitting with three ports and provides for two bent tube nozzles.

FIG. 34 is the same bidet assembly shown of FIG. 33 except that the two bent tube nozzles are replaced with two 90° elbow tube fittings.

FIG. 35 is a perspective view showing the FIG. 34 bidet assembly, using a basic “C” clamp mounting means, as installed in a toilet, which is shown as a vertical cross-section and view at an oblique angle.

FIG. 36 is a perspective view showing the FIG. 34 bidet assembly, using a long and stiff member mounting means, as installed in a toilet, which is shown as a vertical cross-section and view at an oblique angle.

FIG. 37 is the same bidet assembly of FIG. 34 showing the independent arc of rotation on a vertical plane for each nozzle.

FIG. 38 is a perspective view showing an embodiment example of a bidet assembly wherein one end of the water supply tube has a “L” shape bent before connecting to a “T” tube fitting with three ports and provides for two 90° elbow tube fitting nozzles.

FIG. 39 is a perspective view showing the FIG. 38 bidet assembly, using a basic “C” clamp mounting means, as installed in a toilet, showing only a cut-away portion of a toilet bowl's rear end in a vertical cross-section and view at an oblique angle.

FIG. 40 is a perspective view showing the FIG. 38 bidet assembly, using a long and stiff member mounting means—which is placed under and supporting said bidet assembly—as installed in a toilet, showing only a cut-away portion of a toilet bowl's rear end in a vertical cross-section and view at an oblique angle.

FIG. 41 is a perspective view showing the FIG. 38 bidet assembly, using a long and stiff member mounting means, which is placed on top of and tied to said bidet assembly.

FIG. 42 is a perspective view showing the FIG. 41 bidet assembly, as installed in a toilet, showing only a cut-away portion of a toilet bowl's rear end in a vertical cross-section and view at an oblique angle.

FIG. 43 is a perspective view showing an embodiment example of a bidet assembly similar to said bidet assembly shown in FIG. 41, except that said long and stiff member, instead of being tied to the “T” tube fitting, the “T” tube fitting has a built-in bridge with a hole through which said long and stiff member is threaded through.

FIG. 44 is a perspective view showing the FIG. 43 bidet assembly, as installed in a toilet, showing only a cut-away portion of a toilet bowl's rear end in a vertical cross-section and view at an oblique angle.

FIG. 45 is a perspective view showing the FIG. 38 bidet assembly, using an adhesive mounting means holding the vertical water supply tube to a toilet bowl lip's rear vertical surface, as installed in a toilet, showing only a cut-away portion of a toilet bowl's rear end in a vertical cross-section and view at an oblique angle.

FIG. 46 is a perspective view showing an embodiment example of a bidet assembly similar to said bidet assembly shown in FIG. 41, except using a narrower “U” shape rod, which is also shorter than said long and stiff member of FIG. 41, but is similarly tied to said “T” tube fitting.

FIG. 47 is a top front view of the bidet assembly of FIG. 46.

FIG. 48 is a top front view of the bidet assembly shown in FIGS. 46 and 47, as installed in the rear of a toilet bowl with a rod and a plate hanging mounting means. The bowl's lip vertical face 8 is partially cut away in order to show the otherwise covered BLE bidet assembly.

FIG. 49 is a vertical cross-section taken along the line 10-10 of a conventional toilet shown in FIG. 3 and view at an oblique angle in the direction of the arrows. This is the first figure that shows details of the flush valve assembly 90 and flush water channels 91 inside the annular cavity of a toilet bowl. Not shown are the float ball and its connecting rod.

FIG. 50 is vertical cross-section of a conventional toilet shown in FIG. 49 but viewed from the side. Another difference from FIG. 49: The flush valve assembly 90 was rotated clockwise facilitating showing its vertical cross-section.

FIG. 51 is a perspective view showing another preferred embodiment example of a bidet assembly in this present invention, as installed in a toilet, shown in FIG. 49.

FIG. 52 is a perspective view of the same bidet assembly, shown in FIG. 51, as installed in a toilet, shown in a cross-sectional view as in FIG. 50.

FIG. 53 is a perspective view showing a variation of the bidet assembly shown in FIG. 51 with the porthole 104 for the bidet assembly tube nozzle 103 being under the lip surface 6.

FIG. 54 is a perspective view of a flush valve assembly wherein the valve is a flat dish instead of a cone-shaped ball.

FIG. 55 is a cross-sectional view of an example of a jet nozzle head 105 fitted over the end of tube nozzle 101 in a cut-away view of the toilet shown in FIG. 51, showing just the area around the bidet tube nozzle 101 and water supply tubing 99 in the toilet rear section.

FIG. 56 shows the enlargement of the cross-sectional view of the jet nozzle head 105 and identifies all its parts.

FIG. 57 shows the cross-section of another jet nozzle head with a smaller tail outer diameter so that the tail is insertable into the end part of the tube nozzle, as installed in a similar cut-away view of toilet shown in FIG. 55.

FIG. 58 is a perspective view of a bidet assembly having two tube nozzles 101 connected to two ports of a flexible-tube tee fitting 110, whose third port is connected to the water supply tubing 99.

FIG. 59 is a perspective view of a bidet assembly having two elbow jet nozzles 80 connected to two ports of a tee fitting 79, whose third port is connected to a tube nozzle 101.

FIG. 60 is a perspective view of a bidet assembly having two “Z” shape tube nozzles 103, which protrude out of two portholes underneath the toilet lip under-surface 6 and whose other ends are connected to two ports of a flexible-tube tee fitting 110, whose third port is connected to the water supply, tubing 99.

FIG. 61 is a perspective view of a bidet assembly having two elbow jet nozzles 80 connected to two ports of a tee fitting 79, whose third port is connected to a tube nozzle 103. With this bidet assembly, the two elbow jet nozzles 80 can be individually rotated, about its individual connected port, to adjust the angle of water jet streams.

FIG. 62 is a perspective view of a men's urinal.

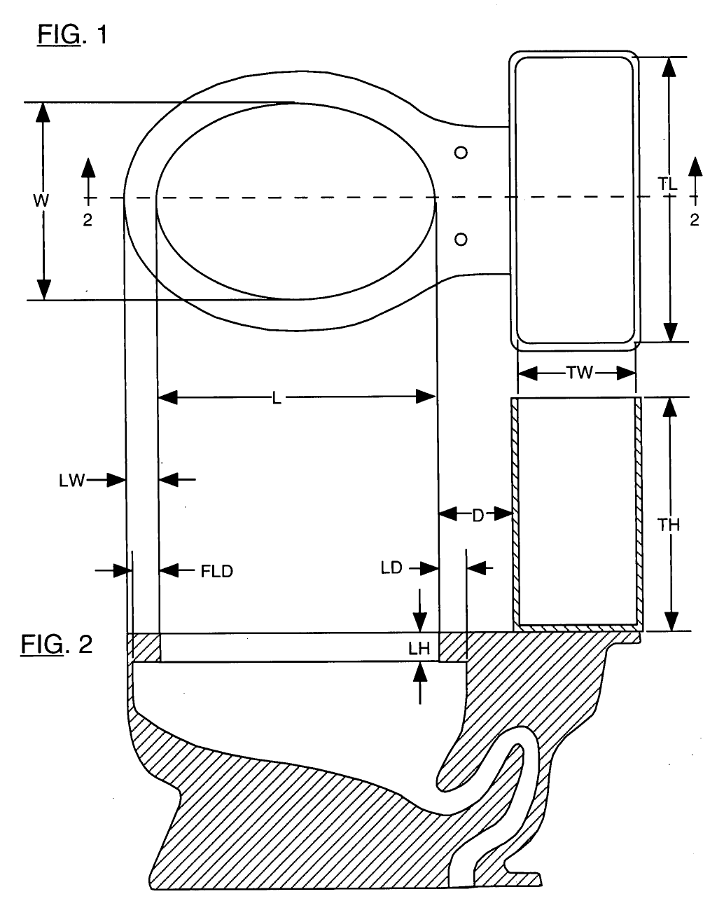

### DETAILED DESCRIPTION OF THE INVENTION

The present invention provides an inexpensive bidet assembly for retrofitting toilets of all sizes and shapes to provide clean jet stream of water for the cleansing of a user's private parts through the normal action of flushing a toilet, without using any controlling devices. The bidet assembly of this invention comprises a nozzle connected to a water supply tube and a non-permanent mounting means for holding said nozzle inside a toilet bowl, either on or under the lip 1 of toilet bowl 18. Such strategic placement of said nozzle keeps jet stream of water within the bowl inner chamber prevents water from spraying or splashing out of the bowl. The bidet assembly of this invention meets sanitary requirements and is easily installed within the confines of a toilet tank and bowl, with either all or most of its parts not visible, therefore it is not unsightly.

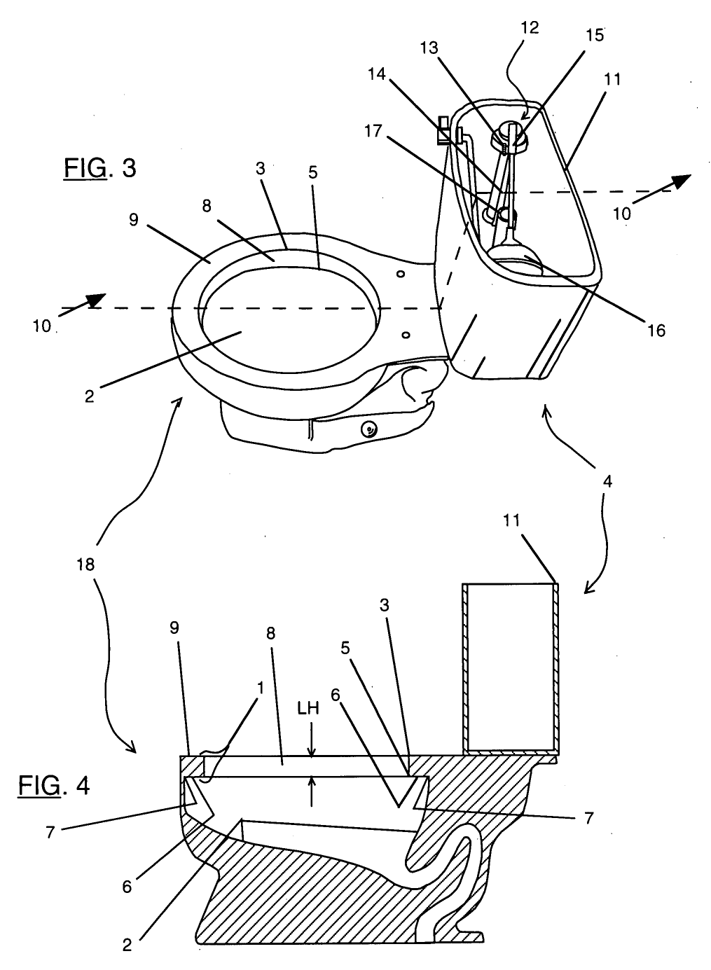

A perspective view of a conventional toilet is shown in FIG. 3 without the toilet cover, seat and tank cover. A cross-sectional view of a conventional toilet is shown in FIG. 2 and FIG. 4, without the toilet cover, seat, tank cover and tank contents.

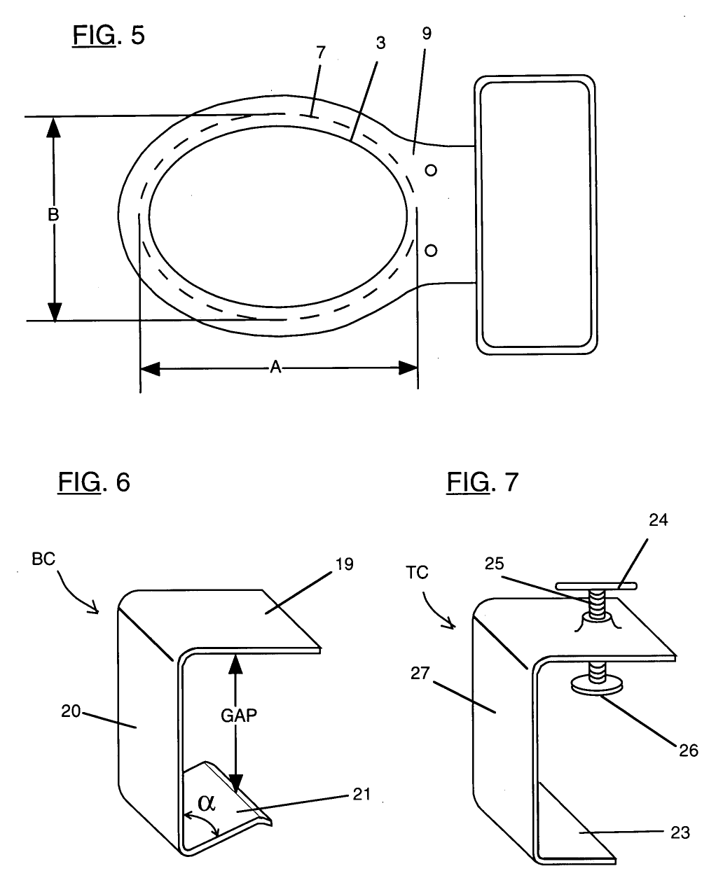

The toilet bowl 18 has a lip 1 and inside surface 2. Said lip 1 comprises a top rim corner edge 3, a bottom rim corner edge 5, an underside horizontal surface 6, an underside rear corner edge 7, a vertical face 8, and a top surface 9, whose surface extends toward and under the toilet tank 4. Each of said parts, except for top surface 9, inner surface 2 and tank 4, has an elliptical shape when viewed from the top. This is shown in FIG. 5. The thickness of lip 1 is referenced by LH.

The toilet tank 4 has a top rim 11. Inside tank 4 is a ballcock 12, which comprises a bowl refill nipple 13, a tank refill pipe 14, a valve control rocker arm 15 attached to a ball float 16, and an overflow pipe 17.

The said non-permanent mounting means of this present invention of a bidet assembly provides the advantages of quick and easy installation and removal, not marring nor permanently damaging a toilet, which would have happened with conventional installation means using adhesives, screws or bolts. This invention of a bidet assembly also has no moving parts, which can break down. These benefits appeal not only to homeowners but also especially to home renters, who can take said bidet assembly with them when they moved and install it in their new residence.

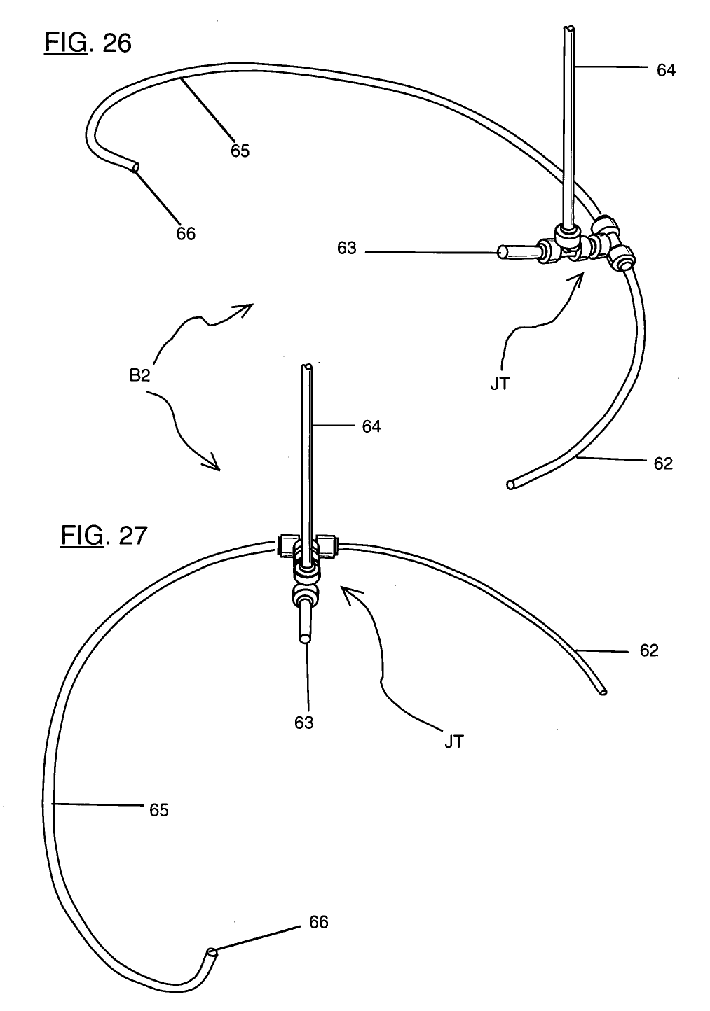

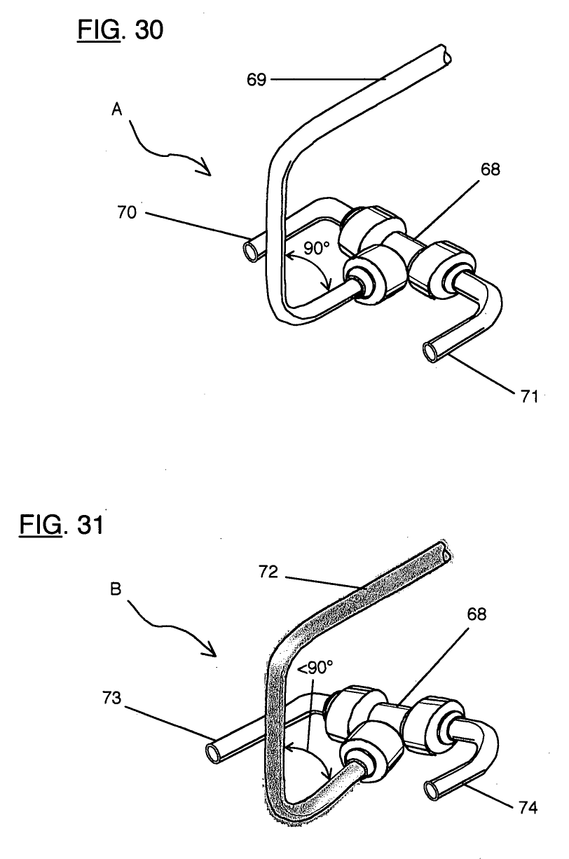

If a single nozzle is mentioned in some bidet assembly, it is understood that additional nozzles can be added through the use of one or more tube fittings to provide more ports for the connection of additional nozzles. Examples of said embodiment of tube fittings providing at least one nozzles are shown in FIGS. 26, 30, 33, 34, 58 and 60. In all of these examples, the shape of one end of their water supply tube varies from a “U”, a “Z, and a “L”. Although the “T” tube fitting is preferably used in said examples, other tube fitting configurations can also be used.

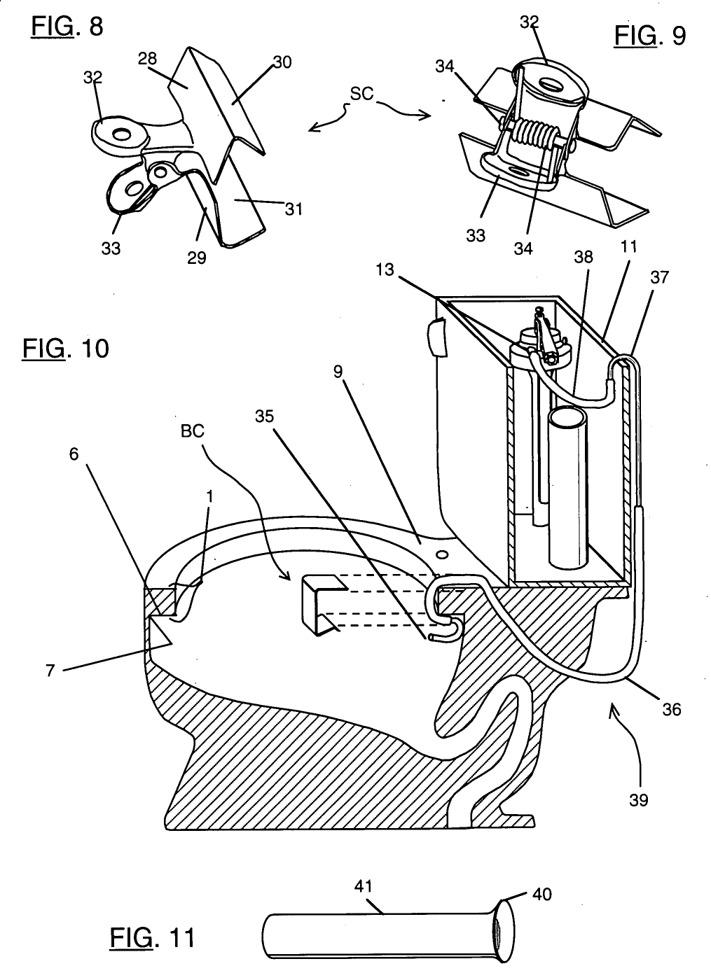

An embodiment example of said non-permanent mounting means in this present invention of a bidet assembly is a “C” clamp device that wedges the water supply tube and the connected end of a nozzle on bowl lip 1 of a toilet. Three embodiment examples of said “C” clamp device are the basic “C” clamp BC of FIG. 6, the threaded rod tightening-clamp TC of FIG. 7, and the spring-loaded clamp SC of FIG. 8 and FIG. 9. These clamps adapt to a variety of bowl lip 1 thickness LH by having the height of each of the vertical parts 20, 27, and the combined height of 28 and 29 at least higher than the thickest lip 1 of toilet bowls in the market. The manner by which each of said clamps adjust to lesser bowl lip 1 thickness LH is different and is discussed in succeeding paragraphs.

The basic “C” clamp in FIG. 6 is a one piece three segments unit. The top segment 19 is generally perpendicular to vertical segment 20. The bottom segment 21 is at an angle α less than 90 degree, preferably 45 degree, to the vertical segment 20. Said bottom segment 21 adjusts to lesser bowl lip 1 thickness LH by the flex opening of the bottom segment 21 which thereby increases the GAP distance between said top segment 19 and the highest surface of said bottom segment 21. Said flexing occurs as the basic “C” clamp BC, shown in FIG. 10, is pushed forward and wedges nozzle 35 and water supply tube 39, which is wrapped around lip 1, on the rear portion of lip 1. In this embodiment example, said water supply tube 39 comprises of three sections: a first section of flexible tube 36, a second section of rigid inverted “U” tube 37, and a third section of flexible tube 38.

FIG. 10 shows the preferred connection arrangement in a toilet, shown without its seat, cover and tank cover, as a vertical cross-section taken along the line 10-10 of a conventional toilet shown in FIG. 3 and view at an oblique angle in the direction of the arrows. The first end of first section 36 is connected to tube nozzle 35. The other end of first section 36 is connect to one end of the second section 37, whose other end is connected to one end of the third section 38, whose other end is connected to the bowl refill nipple 13. The preferred way of keeping these water supply tube sections from view is by passing the first section of flexible tube 36 under a toilet seat between the seat bolting connections, under and up behind the toilet tank and then connects to the inverted “U” tube 37, which hangs on the rear tank top edge 11. A rigid material is preferred for said inverted “U” tube 37 to prevent from collapsing under the weight of a toilet tank cover.

The end portions of nozzle 35 and inverted “U” tube 37 that are connected to flexible tubing are preferably flared, shown in FIG. 11, in order to keep a flexible tubing from sliding off easily. The flare end has a similar effect as that of a single barbed tube fitting. A flared end 40 provides easier, faster and less costly way for making connection compared to conventional means of using a hose clamp or a tube-to-hose fitting.

The application of the threaded rod tightening-clamp TC, shown in FIG. 7, is used in place of the basic “C” clamp in FIG. 10. Said TC clamp provides a handle 24 for hand turning threaded rod 25 forcing plate 26 down and closing the gap between 26 and 23 until it tightens water supply tube 36 and nozzle 35 assembly around toilet bowl's lip 1.

The spring-loaded clamp SC shown in FIG. 8 and FIG. 9 is in the close position. Squeezing the handles 32 and 33 together separates the two clamp surfaces 30 and 31. Upon release of said handles, said clamp surfaces 30 and 31 clamp down upon and hold said nozzle 35 and water supply tube 36 on bowl's lip 1 (see FIG. 10 and visualize the spring-loaded clamp SC in place of the basic clamp BC) for a range of bowl lip thickness.

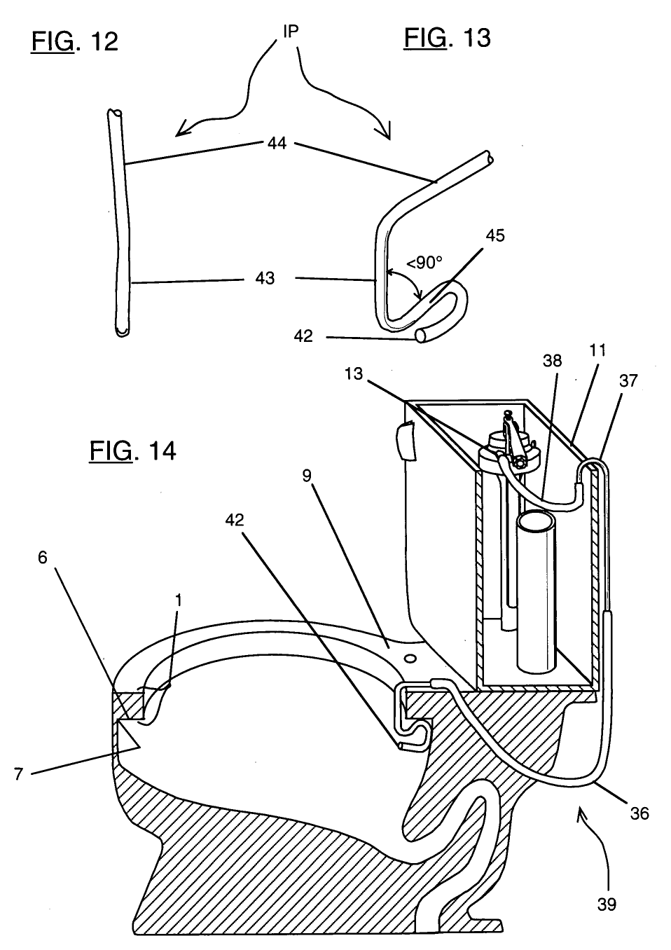

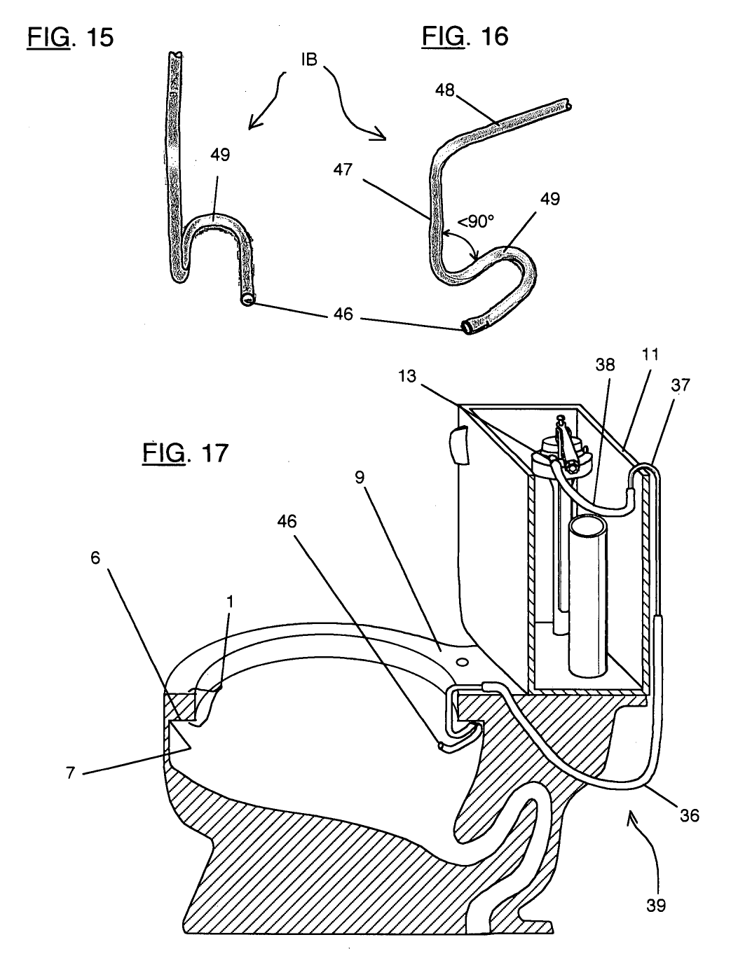

A further embodiment of the present invention of a bidet assembly with a non-permanent securing means of “C” clamps wherein the basic “C” clamp, water supply tube and nozzle form one integral tubing unit. Said integral bidet assembly is made of stiff and rigid tube, preferably metal, such as stainless steel and copper. The required characteristics for clamping onto a bowl's lip 1 are the same as the basic “C” clamp BC shown in FIG. 6. Two embodiment examples are shown in FIG. 12, FIG. 13, FIG. 15, and FIG. 16.

FIG. 12 is a top front view of an integral “C” clamp bidet assembly IP of the present invention wherein the nozzle is on the same dimensional plane as the water supply tube clamping segments while FIG. 13 is its perspective view. Vertical segment 43, top segment 44, which is also the water supply tube, and bottom segment 45 form the “C” clamp. Similar to the basic “C” clamp, the angle between vertical segment 43 and bottom segment 45 is less than 90°, and is preferably 45°. A further preferred embodiment of this integral “C” clamp bidet assembly IP of the present invention is that the water supply tube comprises of the three-sections water supply assembly 39, as shown in FIG. 14: a first section of flexible tube 36, a second section of rigid inverted “U” tube 37, and a third section of flexible tube 38. The first end of first section 36 is connected to a shorten top segment 44 while its other end is connect to one end of second section 37, whose other end is connected to one end of third section 38, whose other end is connected to bowl refill nipple 13. Preferably, the end of rigid tubes connected to flexible tube has a flare.

FIG. 15 is a top front view of an integral “C” clamp bidet assembly IB of the present invention wherein tube nozzle 46 is on a separate plane as the “C” clamp segments while FIG. 16 is its perspective view. The plane of tube nozzle 46 in this embodiment example is perpendicular to the “C” clamp segments. The angle between vertical segment 47 and bottom segment 49 is less than 90°, and is preferably 45°. A further preferred embodiment of this integral “C” clamp bidet assembly IB of the present invention is for the water supply tube of said integral “C” clamp bidet assembly IB to comprise of the three-sections water supply assembly 39, as shown in FIG. 17: a first section of flexible tube 36, a second section of rigid inverted “U” tube 37, and a third section of flexible tube 38. The first end of first section 36 is connected to a shorten top section 48 while its other end is connect to one end of second section 37, whose other end is connected to one end of third section 38, whose other end is connected to bowl refill nipple 13. Preferably, the end of rigid tubes connected to flexible tube has a flare.

Although a single tube nozzle is shown for the “C” clamp bidet assemblies, as shown in FIG. 10, additional nozzles can be added through the use of one or more multi-port fittings to provide additional ports for the connection of additional nozzles. FIG. 31 shows a bidet assembly B wherein the water supply tube 72 is connected to a “T” fitting 68 to provide two ports for two tube nozzles, 73 and 74.

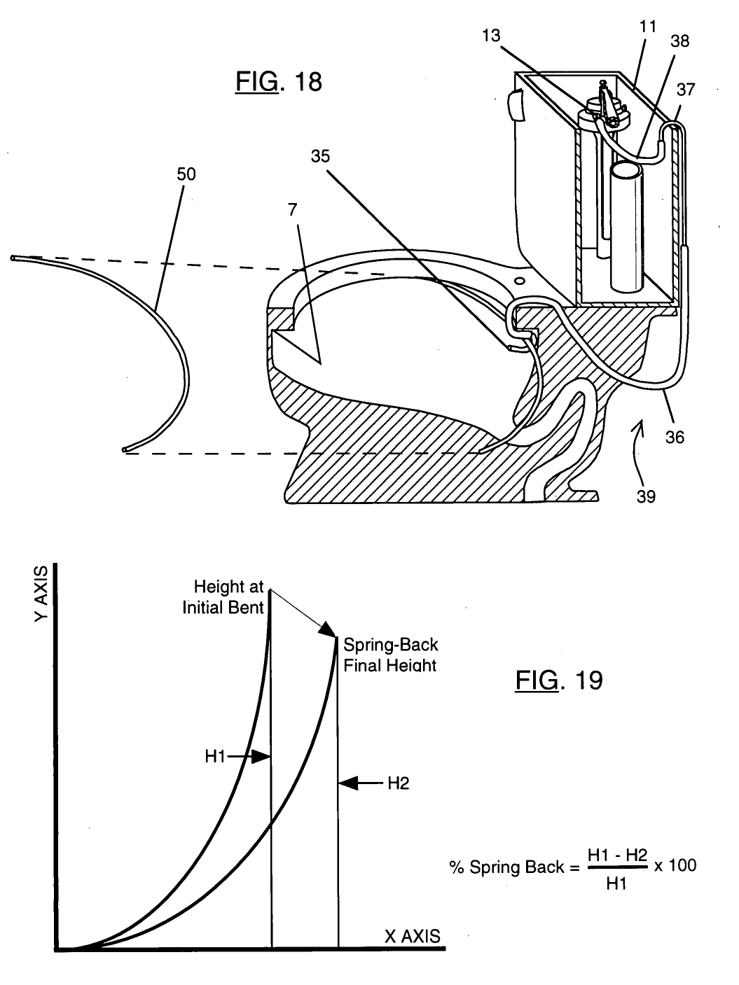

Another embodiment example of said non-permanent mounting means in this present invention of a bidet assembly is a long and stiff member 50 having a spring-back property, shown in FIG. 18, that wedges bidet tube nozzle 35 against the toilet bowl surface below the lip's underside 6 after said member 50 was bent—to pass through the bowl opening—and then released. Said member 50, however, is restrained from recovering to its initial wider form by the narrower bowl's inside surface. This restraint produces a force, due to its spring-back property, that wedges member 50 along the bowl's inside surrounding sloping surfaces—below lip underside 6—and also presses nozzle 35 against the bowl rear surface. The preferred shape of said long and stiff member 50 is selected from the group consisting of a tube, a rod, and a bar.

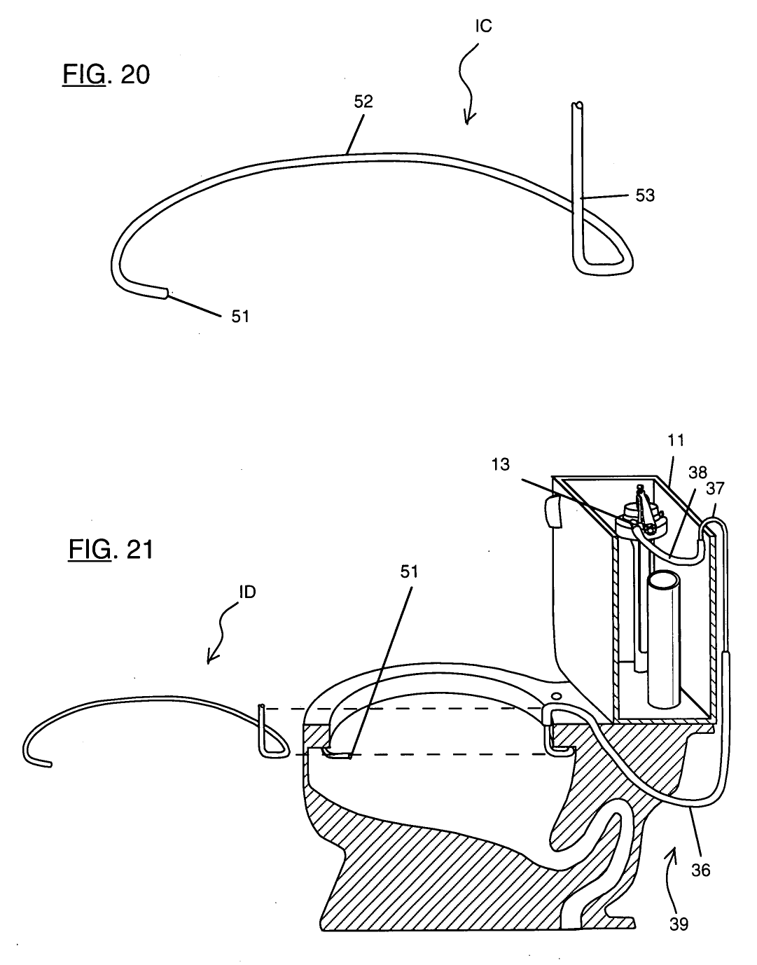

The requirements for said long and stiff member 50 to function as described above, said member 50 must have a length of at least 30% (see Example 1 for details) of the circumference of the underside corner edge 7 for each specific toilet plus a spring-back property of at least 11% (see Example 2 for details), measured by the method shown in FIG. 19.

The procedure for measuring % spring-back is given as follows: take a 14 inches straight length of a long and stiff member 50, clamp two inches of one end with the 2-inch mark at the zero mark along the x-axis on a table. The free end is then bent, along the y-axis by sliding along the surface of said table, to a distance of 10 inches (H1) from the x-axis follow by releasing said free end. The final distance of said free end from the x-axis is H2. The difference between H1 and H2 divided by H1 times a 100 is the member % spring-back property. A complete recovery to a straight line has a 100% spring-back property because its H2 value is zero. The measured % spring-back value for a ¼″ OD (outside diameter) copper tube (JMF Company, Bettendorf, Iowa) is 1.2% while that for 20 gauge galvanize steel wire (Hillman, Cincinnati, Ohio) is 55%.

The shape of underside corner edge 7 is approximately an ellipse (FIG. 5) and the formula for calculating the circumference of an ellipse is:

Circumference=3.1416×\sqrt{a²+b²/2}

### Where a=A/2 and b=B/2.

A further embodiment of said long and stiff member in this present invention of a bidet assembly as a means for mounting a nozzle and water supply tube is an endless loop. Said endless loop can achieve the same result of wedging and firmly holding a nozzle and water supply tube assembly against a bowl's inside wall surface under bowl lip 1 even with % spring-back of less than 11%.

A still further embodiment of a long and stiff member as a said non-permanent securing means in this present invention of a bidet assembly is that said long and stiff member, a nozzle, and water supply tube become an integral unit fabricated from a single stiff tube. FIG. 20 shows such an embodiment example of an integral unit IC wherein nozzle 51 is one of the end segment, the long and stiff mounting member 52 is the middle segment, and the water supply 53 is the last segment. The long and stiff member segment 52 serves a dual function of mounting onto a toilet bowl and providing water to the nozzle.

A still further embodiment of said integral unit IC is that the water supply segment 53 comprises of the three-sections water supply assembly 39, as shown in FIG. 21: a first section of flexible tube 36, a second section of rigid inverted “U” tube 37, and a third section of flexible tube 38. The first end of first section 36 is connected to a shorten water supply segment 53 of integral bidet assembly IC while its other end is connect to one end of second section 37, whose other end is connected to one end of third section 38, whose other end is connected to bowl refill nipple 13. Preferably, the end of rigid tubes connected to flexible tube has a flare.

A still further embodiment example of a long and stiff member as a said non-permanent securing means in this present invention of a bidet assembly is that said long and stiff member comprises of two sections, joined by a multi-port tube-to-tube fitting, to form a jointed long and stiff member. With a four-port fitting, a nozzle and water supply tube are connected to the remaining 2 ports. Additional nozzles can be connected with a fitting having more than four ports or additional multi-port tube fitting can be connected.

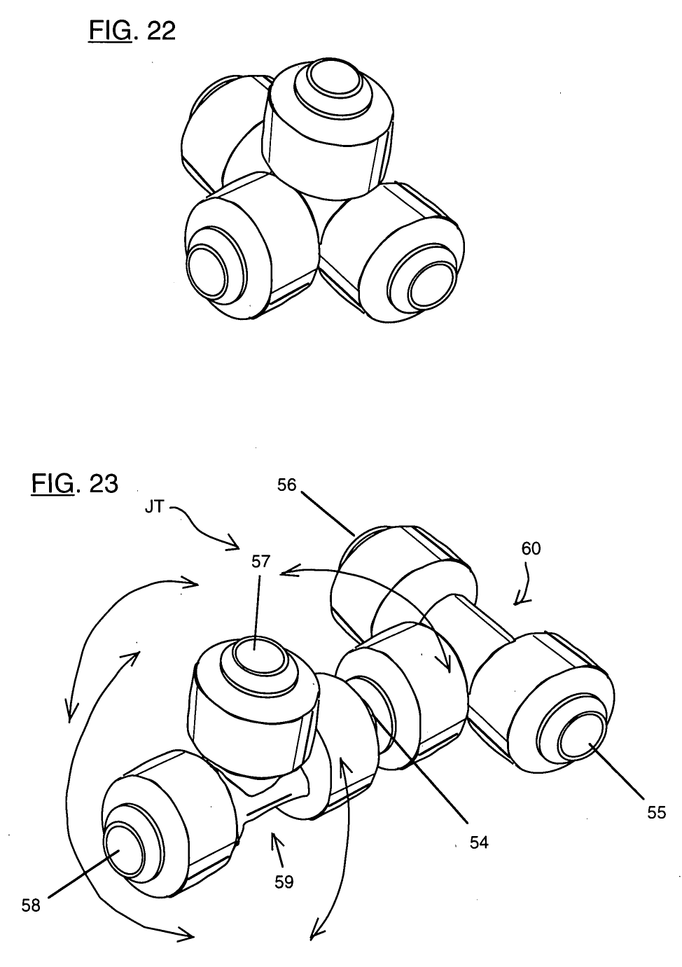

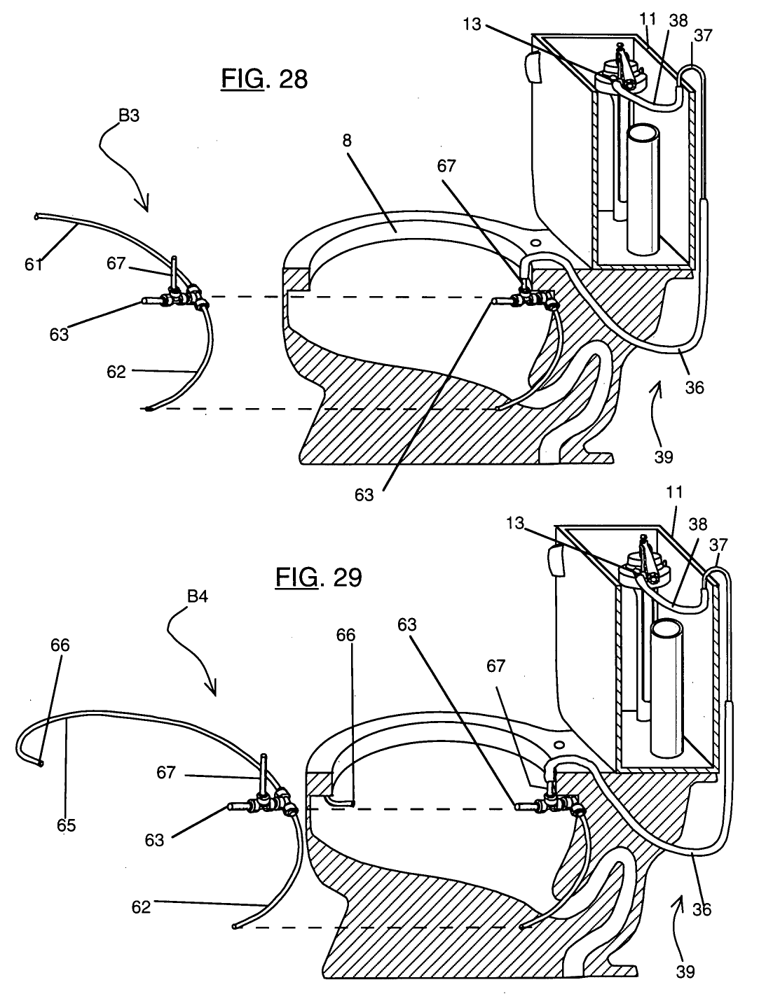

FIG. 22 is a perspective view of an embodiment sample of a four-port tube-to-tube fitting. A preferred embodiment example is shown in FIG. 23, wherein the four ports are created using two “T” tube-to-tube fittings, joined together by a short tube 54. Said two-jointed “T” fitting JT provides the benefits of having two-dimensional rotations. Port 57 can be rotated and thus rendering it easier to connect to the water supply tube 67 in FIG. 28 and FIG. 29. Port 58 can be rotated, on a vertical plane, to adjust the angle of water jet stream, from an inserted nozzle, from high to low. The benefit with the preferred embodiment examples in this invention of a bidet assembly of FIG. 28 and FIG. 29 is that said inserted nozzle 63 can only rotate from and below a horizontal position because the above horizontal position is restricted by the bowl's lip underside horizontal surface 6. This feature ensures that the water jet stream stays below lip 1, keeping the water within the bowl and avoid splashing outside of bowl 18.

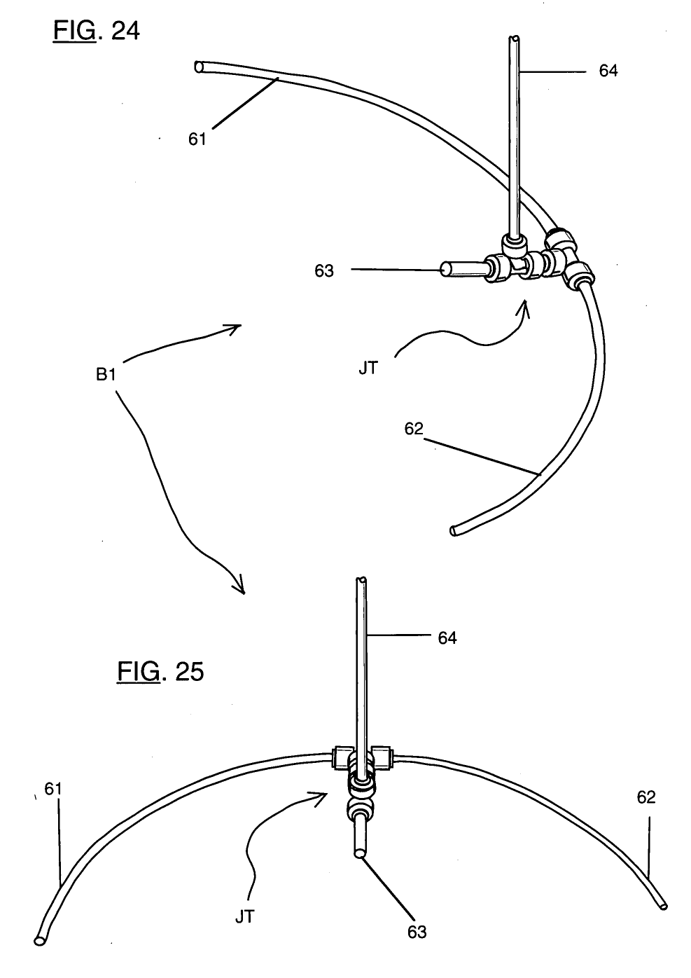

FIG. 24 is a perspective view showing the preferred embodiment of said jointed “T” fitting JT in this present invention of a bidet assembly B1 having one nozzle and FIG. 25 shows its top front view. FIG. 28 shows an embodiment example of said bidet assembly B1 converted to bidet assembly B3 having a shorten initial rigid water supply tube 67 plus the three-sections water supply assembly 39: a first section of a flexible tube 36, a second section of rigid inverted “U” tube 37, and a third section of flexible tube 38. The first end of tube 67 is connected to said jointed “T” fitting JT, while its other end is connect to one end of first section 36, whose other end is connected to one end of second section 37, whose other end is connected to third section 38, whose other end is connected to bowl refill nipple 13. Prior to the connections described above, the bidet assembly B3 with said shorten initial rigid water supply tube 67 is first inserted into the toilet bowl by holding the ends of arm 61 and arm 62 and bending both arms just enough to squeeze pass through the bowl's opening defined by the vertical lip surface 8, followed by releasing the arms. Further adjustment is made to locate the nozzle 63 to the rear center of the bowl by sliding said bidet assembly B3 around the bowl surface under lip 1. Preferably, the end of rigid tube connected to flexible tube has a flare.

FIG. 26 is a perspective view showing the preferred embodiment of said jointed tee fitting JT in this present invention of a bidet assembly B 2 having two nozzles and FIG. 27 shows its top front view. FIG. 29 shows an embodiment example of said bidet assembly B2 converted to bidet assembly B4 comprising a shorten initial rigid water supply tube 67 plus the three-sections water supply assembly 39: a first section of flexible tube 36, a second section of rigid inverted “U” tube 37, and a third section of flexible tube 38. The first end of tube 67 is connected to said jointed “T” fitting JT, while its other end is connect to one end of first section 36, whose other end is connected to one end of second section 37, whose other end is connected to third section 38, whose other end is connected to bowl refill nipple 13. Prior to the connections described above, the bidet assembly B4 is first inserted inside the toilet bowl by holding the ends of arm 62 and arm 65 and bending both arms just enough to squeeze pass through the bowl's opening defined by the vertical lip surface 8, followed by releasing the arms. Further adjustment is made to locate the nozzle to the rear center of the bowl by sliding said bidet assembly B3 around the bowl surface under lip 1. Preferably, the end of rigid tube connected to flexible tube has a flare.

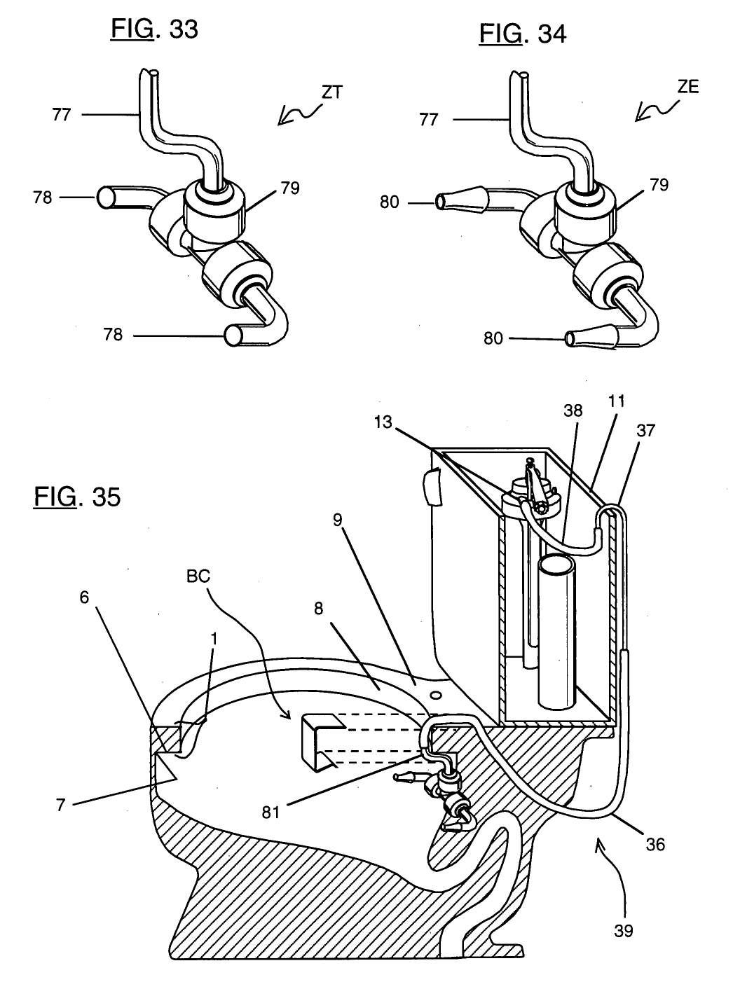

FIG. 33 shows still another preferred embodiment example of this present invention of a bidet assembly showing an assembly ZT, comprising of a water supply tube having one end bent to a “Z” shape 77 connected to a “T” tube fitting 79, which has two connected bent tube nozzles 78.

FIG. 34 shows still another preferred embodiment example of this present invention of a bidet assembly showing an assembly ZE, similar to that of FIG. 33 except 90° elbow flexible single barb tube fittings 80 replaced the bent tube nozzles 78. The use of barbed flexible tube fittings as nozzles provides four advantages: 1. Flexible tube fittings are commercially available merchandise, 2. They have the right dimensions, 3. The barb permits the use of one size smaller diameter flexible tube fitting and yet provides a water-tight seal, 4. They reduce the tube fitting's diameter to a much smaller diameter thereby resulting in a finer and discontinuous water stream spray, which gives a warmer sensation even from a rather chilly cold water source. This effect of reducing a rather chilly cold water to a tolerable cool sensation obviates the need for a warm water source or heater in areas where there is winter. Preferably, 90° elbow 3/16″ flexible tube ID single barb fitting used in conjunction with ¼″ tube OD multi-port fitting.

FIG. 35 shows a preferred embodiment of a bidet assembly using said ZE assembly with the basic “C” clamp BC for its mounting means, as installed in a toilet, wherein the water supply tube 77 is preferably replaced with a short initial “Z” shape tube 81 and said three-sections water supply assembly 39: a first section of flexible tube 36, a second section of rigid inverted “U” tube 37, and a third section of flexible tube 38. The first end of said “Z” shape tube 81 is connected to the “T” tube fitting 79, while its other end is connect to one end of first section 36, whose other end is connected to one end of second section 37, whose other end is connected to third section 38, whose other end is connected to a toilet bowl refill nipple 13.

In this preferred embodiment, the nozzles 80 have a high degree of rotation on a vertical plane thus enabling the nozzles 80 to direct jetting water even above a horizontal plane. This permits a user to direct jetting water upward toward a user's anus area. However, if the user is not sitting on the toilet seat or there is no user and the toilet cover is not down, the nozzles can shoot water outside the toilet.

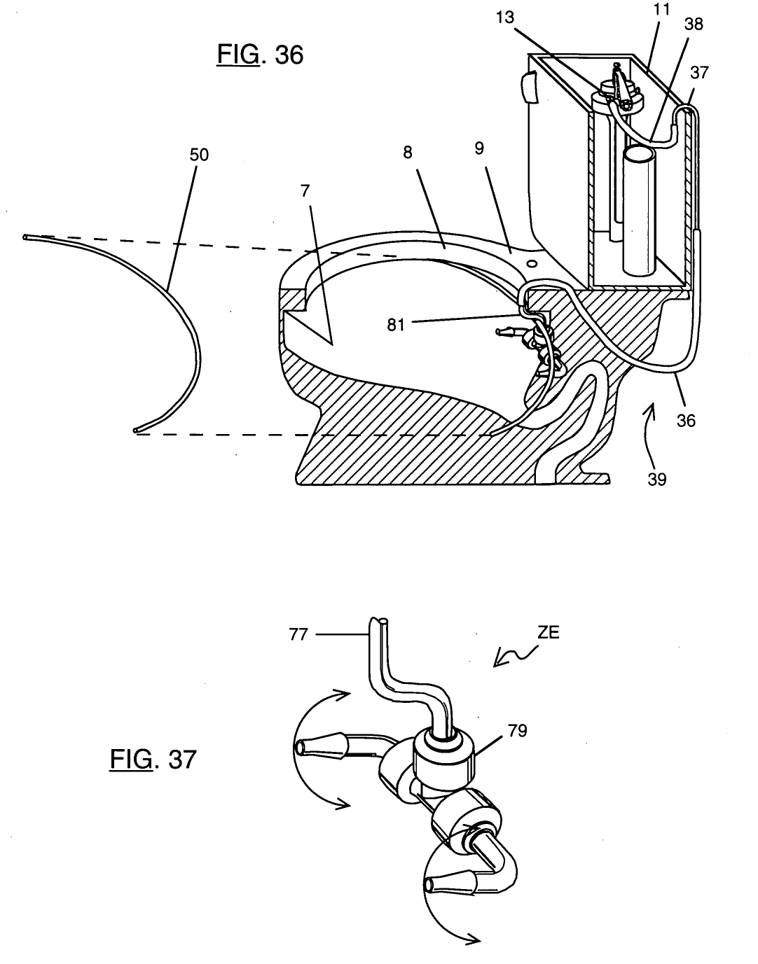

FIG. 36 shows another preferred embodiment of a bidet assembly using said ZE assembly similar to that shown in FIG. 35 except that the long and stiff member 50 is used for its mounting means.

FIG. 37 shows the same ZE assembly of FIG. 34, but also shows the arc of rotation on a vertical plane, independently, for each nozzle. This nozzle's feature gives a user the flexibility to direct each jet stream of water to desired part of a user's private parts. Once each nozzle is set at desired angle before use, no further adjustment or manipulation is required thereafter. Of course, a user can change his or her mind and, just as easily, reset each nozzle angle again.

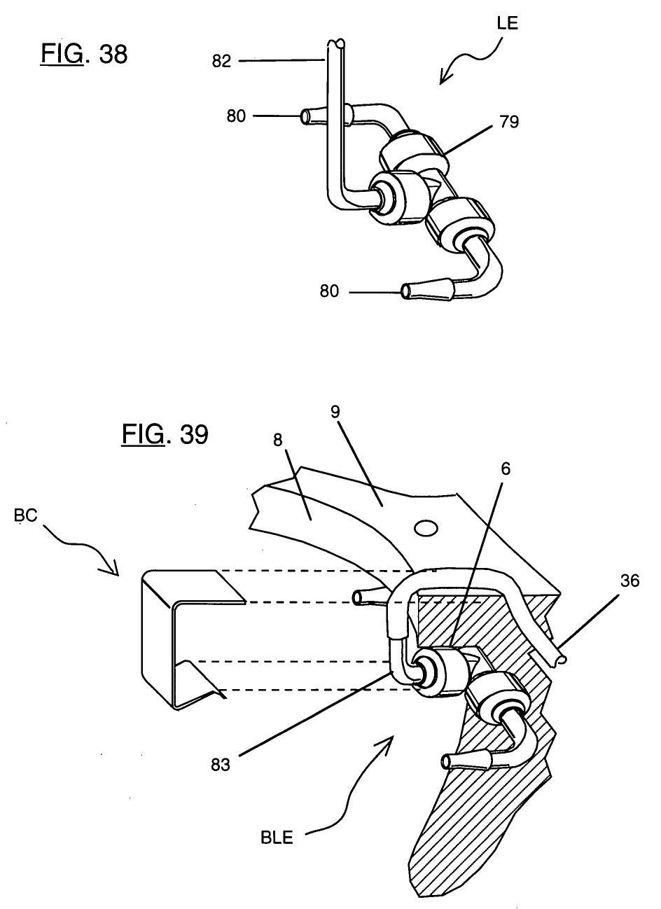

FIG. 38 is a perspective view showing another embodiment example of a bidet assembly showing an assembly LE, wherein one end of the water supply tube 82 has a “L” shape bent instead of the “Z” shape bent water supply tube 77 of FIG. 37. In this embodiment, the “L” shape bent requires one less bending work than the “Z” shape bent and the “T” tube fitting 79 is on a horizontal plane, whereas in said assembly ZE of FIG. 37 the “T” tube fitting 79 is on a vertical plane. FIG. 39 shows a preferred embodiment of the bidet assembly utilizing said assembly LE of FIG. 38 with the basic “C” clamp BC for its mounting means, as installed in a toilet, wherein its water supply tube 82 is preferably replaced with a shorten “L” shape initial tube 83 and said preferred three-sections water supply assembly 39: a first section of flexible tube 36 and other sections similarly described for and shown in FIG. 35. The toilet in this figure shows only a cut-away portion of a toilet bowl's rear end in a vertical cross-section and view at an oblique angle.

The assembly comprising said short “L” shape water tube 83, said “T” tube fitting 79, and said two jet nozzles 80 is given the name “BLE assembly”.

In this preferred embodiment, the horizontal plane of “T” tube fitting 79 is butted up against the bowl's lip underside 6, thereby restricting nozzles 80 from rotating higher than a horizontal plane. This keeps the jet stream of water from shooting higher than the bowl's lip underside 6, thus prevents water from spraying outside a toilet.

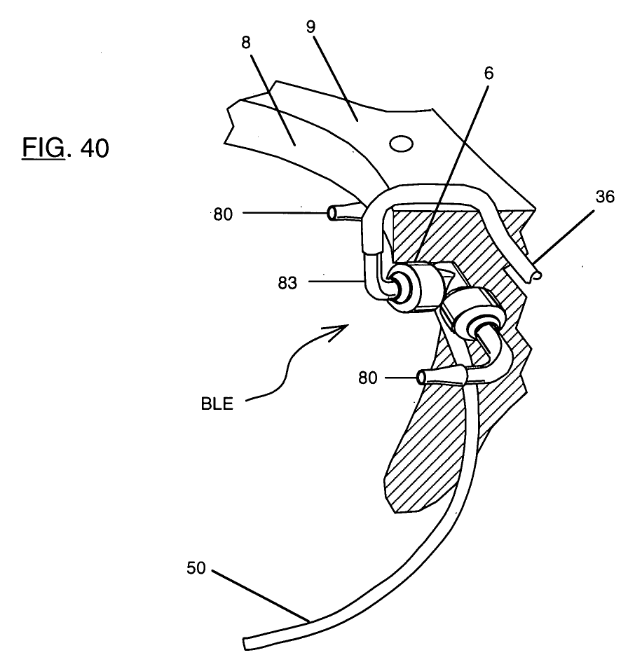

The preferred embodiment of a bidet assembly of FIG. 40 is similar to that of FIG. 39 except that said long and stiff member 50 mounting means is used instead of the basic “C” clamp BC mounting means. In this embodiment, the nozzles 80 are completely restricted from rotation by the bowl's lip underside 6 above them and the long and stiff member 50 below them.

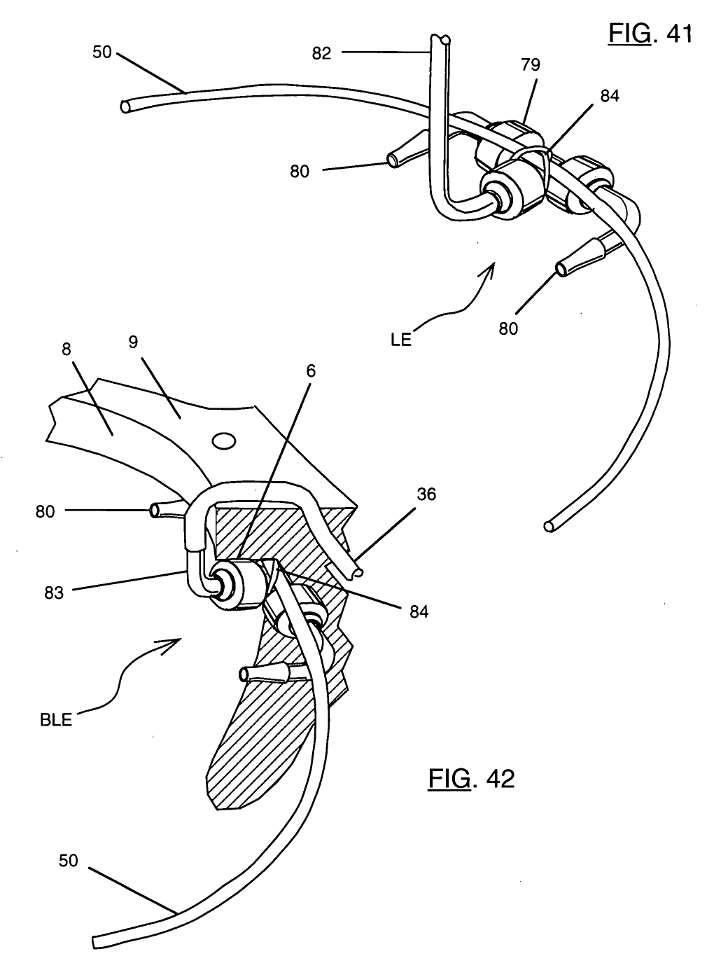

It is usually more preferable to give some degree of rotational freedom to the nozzles 80 using said long and stiff member 50 with said assembly LE. This is accomplished in FIG. 41 by placing said long and stiff member 50 on top of said assembly LE. In this embodiment example, the long and stiff member 50 has to be attached to the LE bidet assembly, which in this embodiment, by a crisscross ties 84. This requirement for attachment becomes obvious when one looks at FIG. 42, which shows the BLE assembly, similar to said LE assembly, except that its water supply tube is replaced with a shorten “L” shape water supply tube, with said long and stiff member 50 above it. The shorten “L” shape water supply tube is connected to the flexible tube 36 of said preferred three-sections water supply system as shown in FIG. 36.

If the BLE assembly is not attached to the long and stiff member 50, the BLE assembly is not secured to the toilet bowl because the flexible tube 36 is incapable of holding it up, therefore, the BLE assembly would fall off.

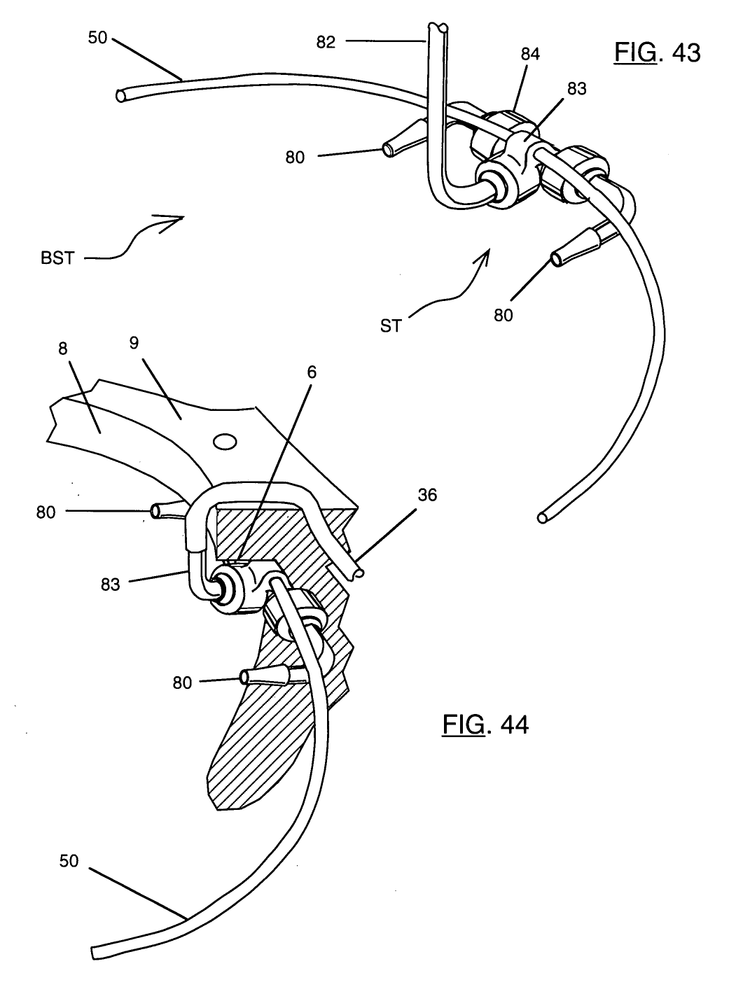

One example of a preferred attachment means, as shown in FIG. 41 and FIG. 42, is using two plastic cable ties, called “zip ties,” in a crisscross pattern. If only a single cable tie is used, although it is strong enough to hold the BLE assembly, the long and stiff member 59 can not sit square with the “T” tube fitting. Another example of an attachment means, shown in FIG. 43 and FIG. 44, is a “T” tube fitting with a built-in bridge 83 with an underneath hole through which said long and stiff member 50 is threaded through.

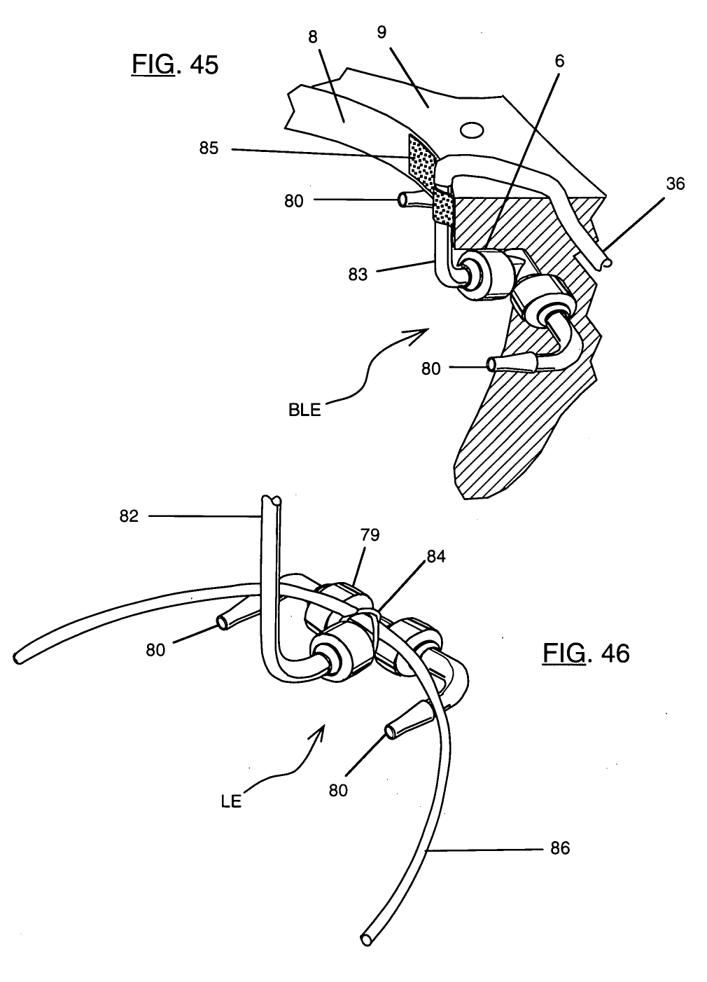

A different means of mounting said BLE bidet assembly to a toilet bowl is adhesive tape 85 as shown in FIG. 45, wherein the short “L” shape water supply tube 83 is taped to the toilet bowl's lip vertical surface 8 with said adhesive tape.

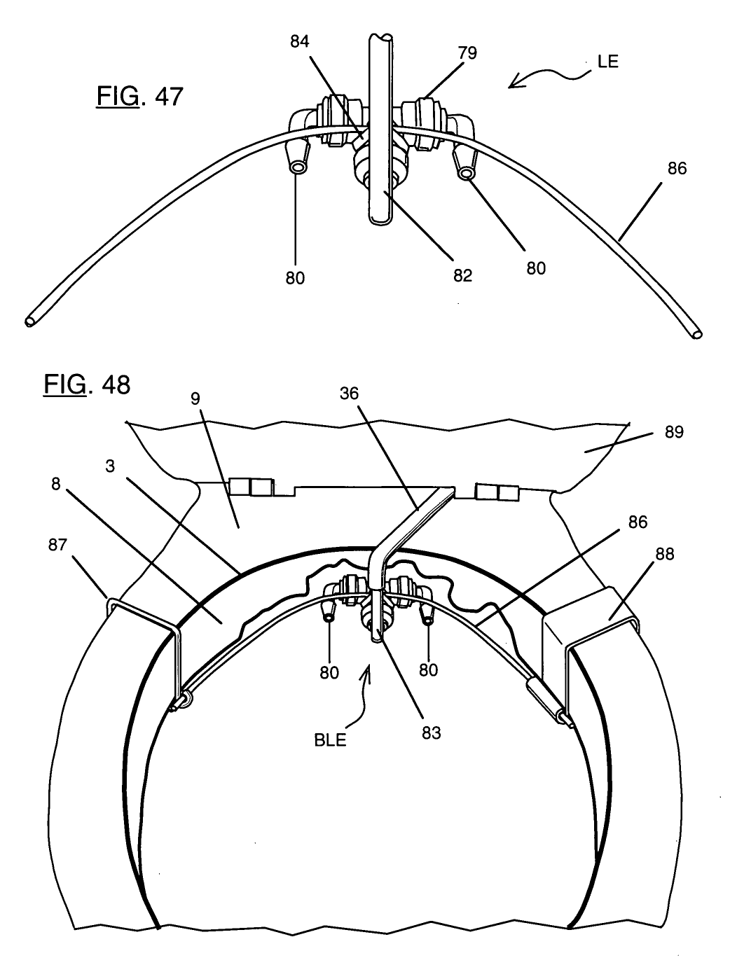

FIG. 46 shows still another means of mounting said LE assembly to a toilet bowl by attaching a short “U” shape rod 86. FIG. 47 shows its top front view. The short “U” shape rod 86 differs from the long and stiff rod member 50, shown in FIG. 41, in four ways: 1. Its shape is bent like a tight “U”, 2. The “U” shape rod is shorter, 3. It does not need to have any spring-back property, 4. It is not a mounting means by itself but needs attached hangers, shown in FIG. 48.

FIG. 48 shows the assembly of FIGS. 46 and 47 as installed in a toilet, wherein said water supply tube 82 is replaced with a initial short “L” shape water supply tube 83 plus the usual three-sections water supply assembly 39 but only the first section of flexible tube 36 is shown in the figure. The toilet in this figure is viewed from top front and shows only a cut-away portion of a toilet bowl's rear end. A portion of the bowl's lip vertical face 8 is also cut away in order to show the otherwise covered BLE bidet assembly. The upper part of the toilet seat 89 has been cut away. The bidet assembly is mounted on the toilet bowl using hangers, chosen from a group consisting of rod hanger 87 and plate hanger 88, attached on the ends of said “U” rod 86.

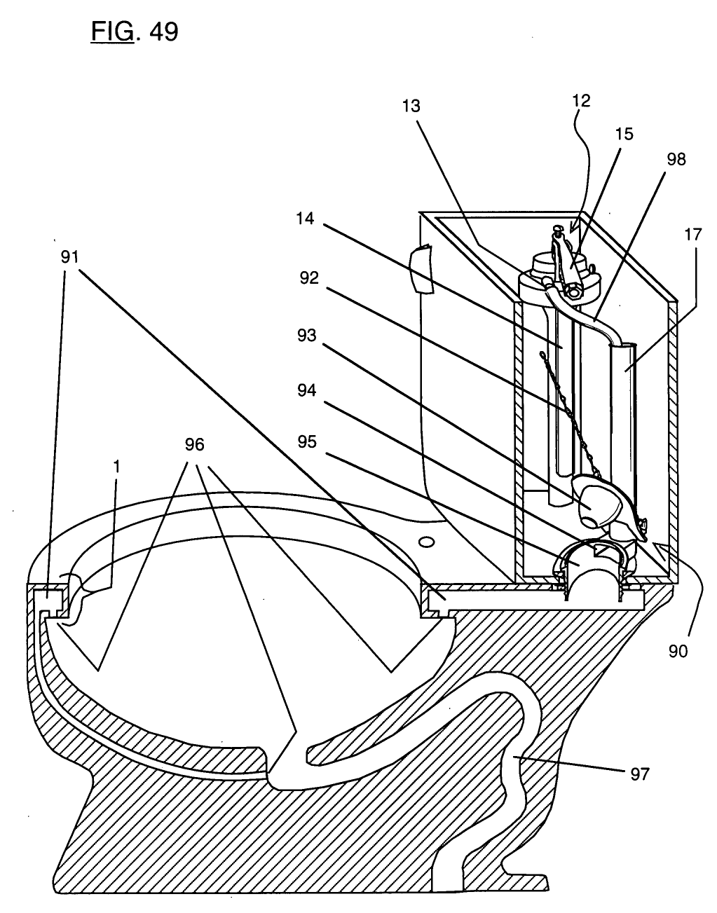

FIG. 49 is a vertical cross-section taken along the line 10-10 of a conventional toilet shown in FIG. 3 and view at an oblique angle in the direction of the arrows. This is the first figure that shows details of the flush valve assembly 90 and flush water channels 91 inside the annular cavity of a toilet bowl. Not shown are the float ball and its connecting rod. The flush valve assembly 90 comprises of (a) tank overflow pipe 17, (b) chain 92, which is used to pull up flapper valve 93, shown in the up and open position, (c) overflow water channel 94, and (d) a short and large diameter threaded pipe 95, which with a rubber ring gasket provides a water-tight seal on the tank bottom hole and which protrudes through the tank-bottom opening into a larger round hole in the toilet rear section and flush channels 91. Another rubber gasket—placed around the protruding threaded pipe 95—gives a water-tight seal between the tank and toilet rear section, aided by two nuts and bolts.

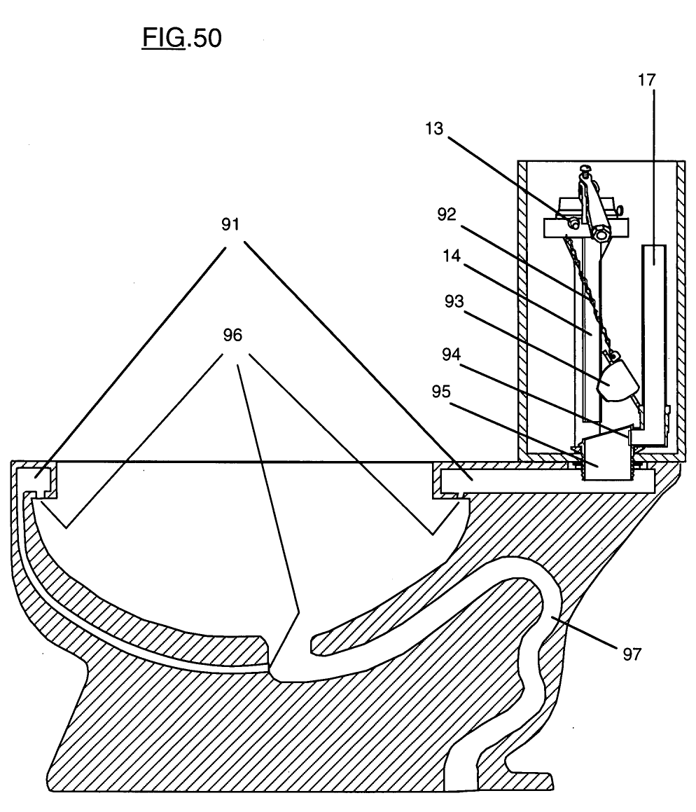

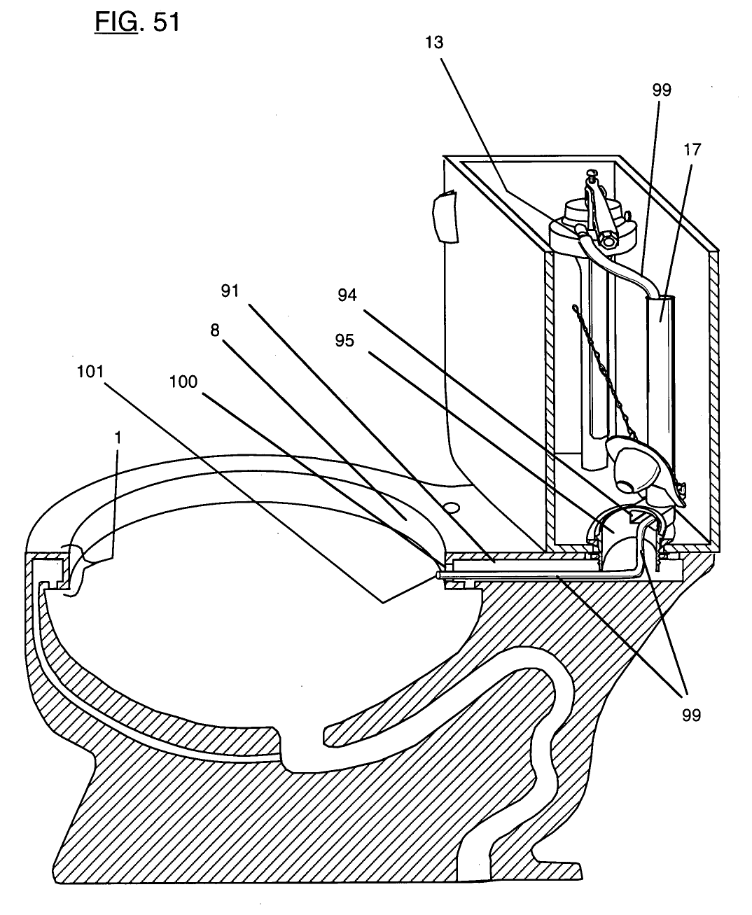

FIG. 50 is vertical cross-section of a conventional toilet shown in FIG. 49 but viewed from the side. This figure is also similar to that of FIGS. 2 and 4 except that the tank contents are now added. Another difference from FIG. 49: The flush valve assembly 90 was rotated clockwise facilitating showing its vertical cross-section.

In a typical toilet flushing operation, the toilet tank handle is pushed down, thus lifting up the chain 92, which pulls up the flapper valve 93. Water in the tank flows down the opened threaded pipe 95 into the toilet flush channels 91 and flows inside the annular cavity of toilet lip 1 and out of the many holes 96—around the bowl rim—and into the toilet bowl. The sudden surge in the volume of water inside the toilet bowl causes the water to flow up and around the inverted “U” toilet flow channel 97. The water flowing down the narrow toilet flow channel 97 creates a vacuum, which sucks out the remaining water from the toilet bowl.

Water coming out of pipe 14 refills the toilet tank and water from the nipple 13 flows through tubing 98 to refill the toilet bowl through the overflow pipe 17. At low water level, the flapper valve 93 lowers itself and seals the top opening of the threaded pipe 95.

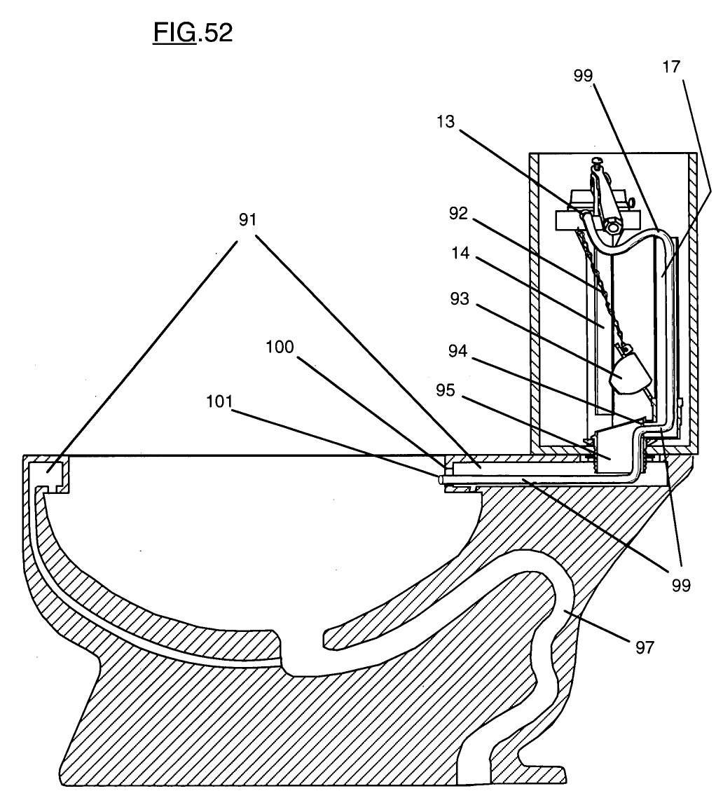

FIG. 51 is a perspective view showing another preferred embodiment example of a bidet assembly in this present invention, as installed in a toilet, shown in FIG. 49. In this bidet assembly, one end of the water supply tube 99 is inserted through a porthole 100, goes through the wall of bowl lip 1 into the toilet rear flush channel 91, continues on through the flush channel 91, goes up the threaded pipe 95, enters the overflow water channel 94, goes up and out of the overflow pipe 17, and is finally connected to the toilet bowl refill nipple 13. The other end of the water supply tube connects to a tube nozzle 101. The complete path of the bidet assembly, comprising of tube nozzle 101 and water supply tube 99, can be seen more clearly in a toilet and flush valve assembly cross-sectional view in FIG. 52.

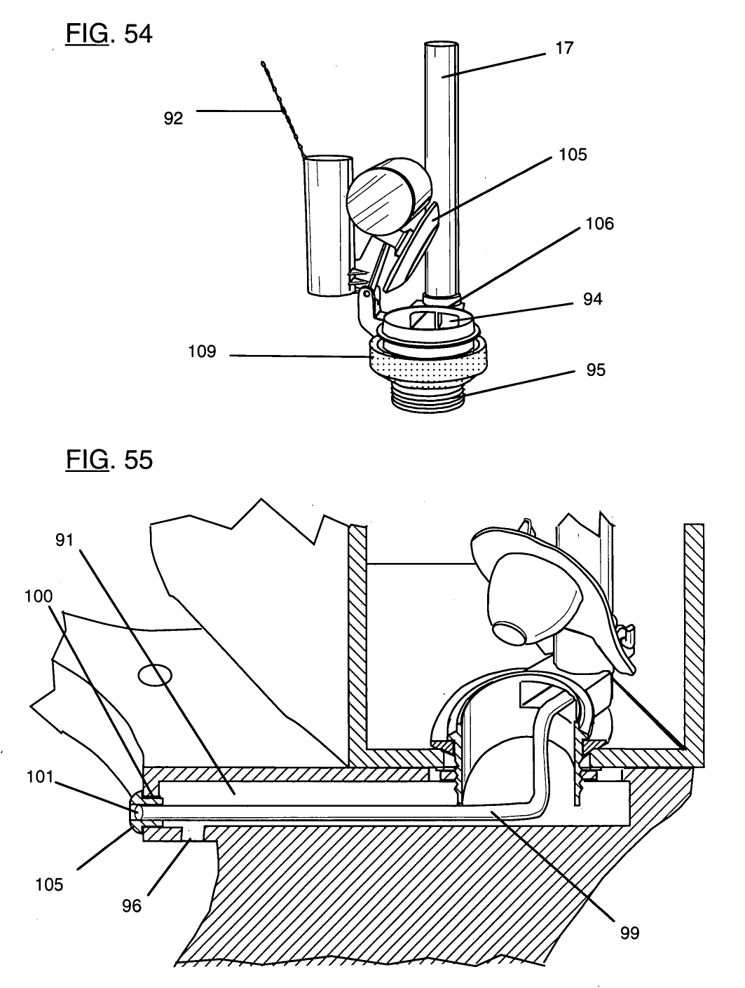

Although there is some space between the wall of the flapper valve ball 93 and the entrance of the overflow water channel 94, the space is limited. Therefore, the water supply tube 99 should be of a small diameter and hugs the inside wall of the threaded pipe 95 to prevent touching the flapper valve ball 93 and, thus obstructing a water-tight seal upon the threaded pipe 95 top rim. This type of problem, however, can be prevented with the use of another type of flush valve assembly as shown in FIG. 54. This flush valve assembly has a bevel-edge flat dish 105, instead of a conical ball, that sits and seals on the top rim 106 of the threaded pipe 95 without extending down and obstructing the entrance of the water channel 94.

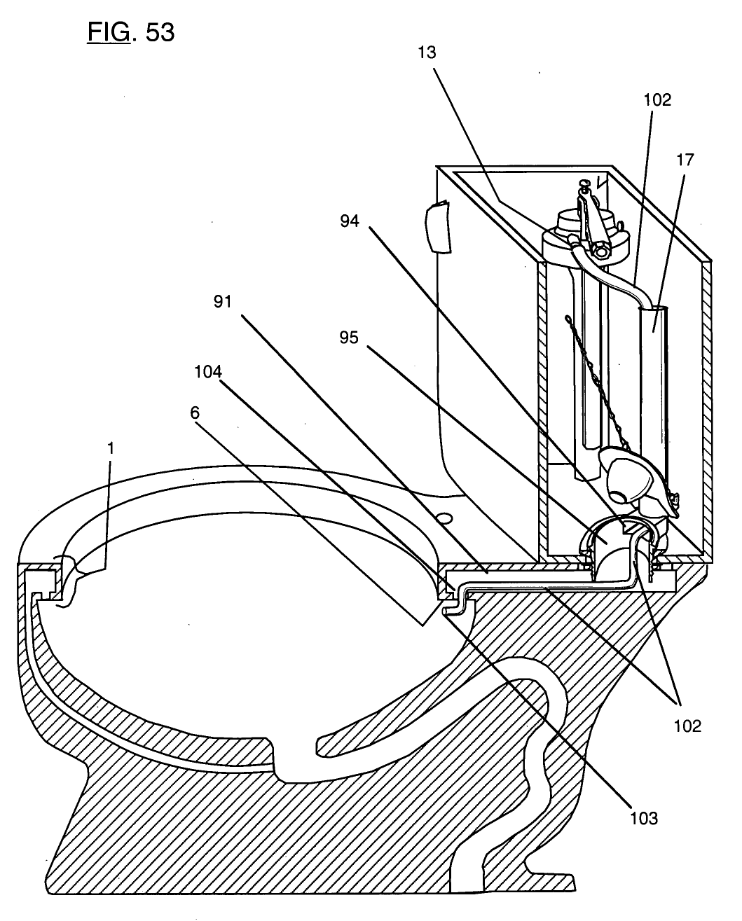

FIG. 53 is a perspective view showing a variation of the bidet assembly shown in FIGS. 51 and 52 with the porthole 104 for the bidet assembly tube nozzle being under the lip surface 6. Except for the difference in the porthole location, this bidet assembly water supply tube 102 follows the same path as that of the bidet assembly of FIGS. 51 and 52. The tube nozzle 103, however, is a “Z” shape bent tube.

Although the porthole 100, shown in FIGS. 51, 52 and 53, are located in the rear of the toilet's lip 1, portholes may be located anywhere on the lip as long as they are open to the annular cavity of the water flushing channel 91 of the toilet.

The above two types of bidet assembly are unique and can be called “bidet toilet combos”. Since all parts of the bidet assembly are inside a toilet, this is the first bidet assembly that is completely hidden from view. With the bidet assembly 99-101, the porthole 100 can be made small to snugly fit the tube nozzle 101, which can also be set flushed with the toilet lip vertical surface 8. With the bidet assembly 102-103, the tube nozzle 103 should be kept shorter than the depth of the lip underside surface 6 and close to it.

FIG. 55 is a cross-sectional view of an example of a jet nozzle head 105 which is inserted over the tube nozzle 101 in a cut-away view of the toilet shown in FIG. 51, showing just the area around the bidet tube nozzle 101 and water supply tube 99 in the toilet rear section. The jet nozzle head 105 is shown enlarged in FIG. 56. The rounded tip surface 106 is the only visible part of the entire bidet assembly. The shoulder 107 provides a stop against the toilet surface, its inner tail diameter 108 preferably fits snugly over a tube nozzle, and its tail outer diameter 109 preferably fits snugly in a porthole.

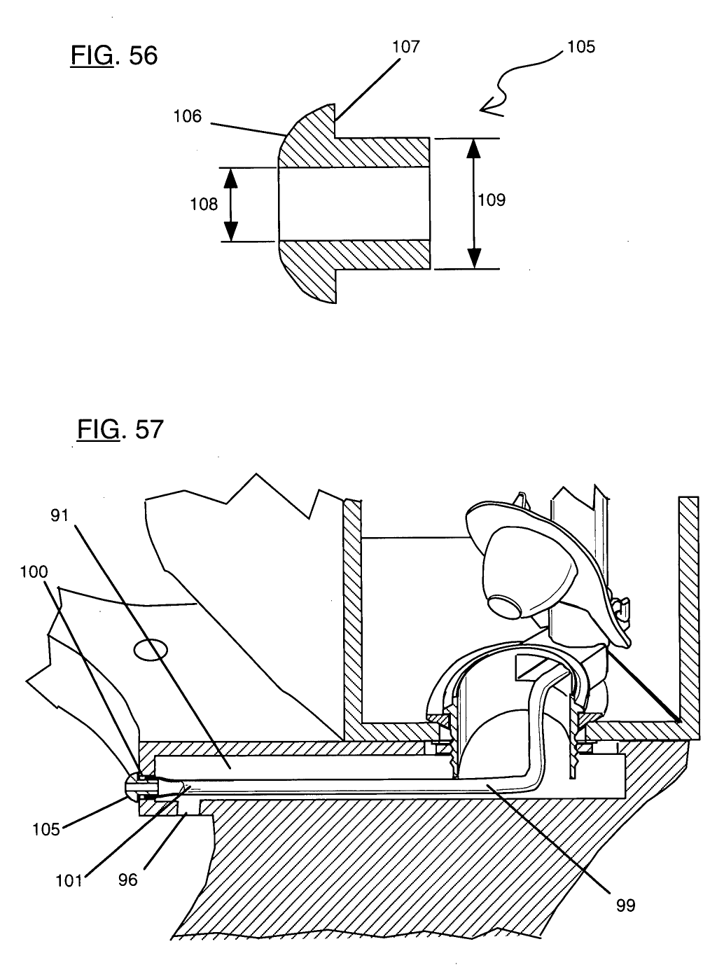

There are many more different ways to attach the bidet tube nozzle 101 to a jet nozzle head 105. The purpose here is not to teach every possible way. Another example is shown in FIG. 57, wherein the jet nozzle head 105 has a smaller tail outer diameter 109, which can be inserted snugly inside the end part of the bidet tube nozzle 101, and the resulting larger outer diameter fits snugly into a porthole 100.

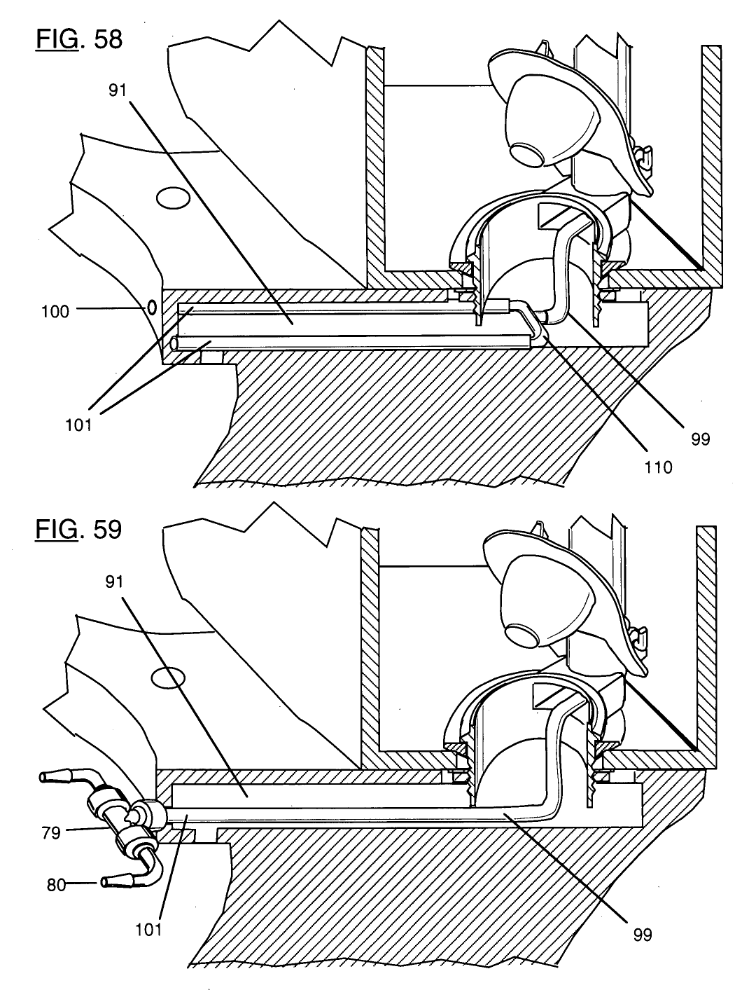

Multiple jet streams of water are achieved using fitting with three or more ports. Examples of two water jet streams are shown in FIGS. 58, 59, 60 and 61.

FIG. 58 is a perspective view of a bidet assembly having two tube nozzles 101 connected to two ports of a flexible-tube tee fitting 110, whose third port is connected to the water supply tubing 99.

FIG. 59 is a perspective view of a bidet assembly having two elbow jet nozzles 80 connected to two ports of a tee fitting 79, whose third port is connected to a tube nozzle 101. With this bidet assembly, the two elbow jet nozzles 80 can be individually rotated, about its individual connected port, to adjust the angle of water jet streams.

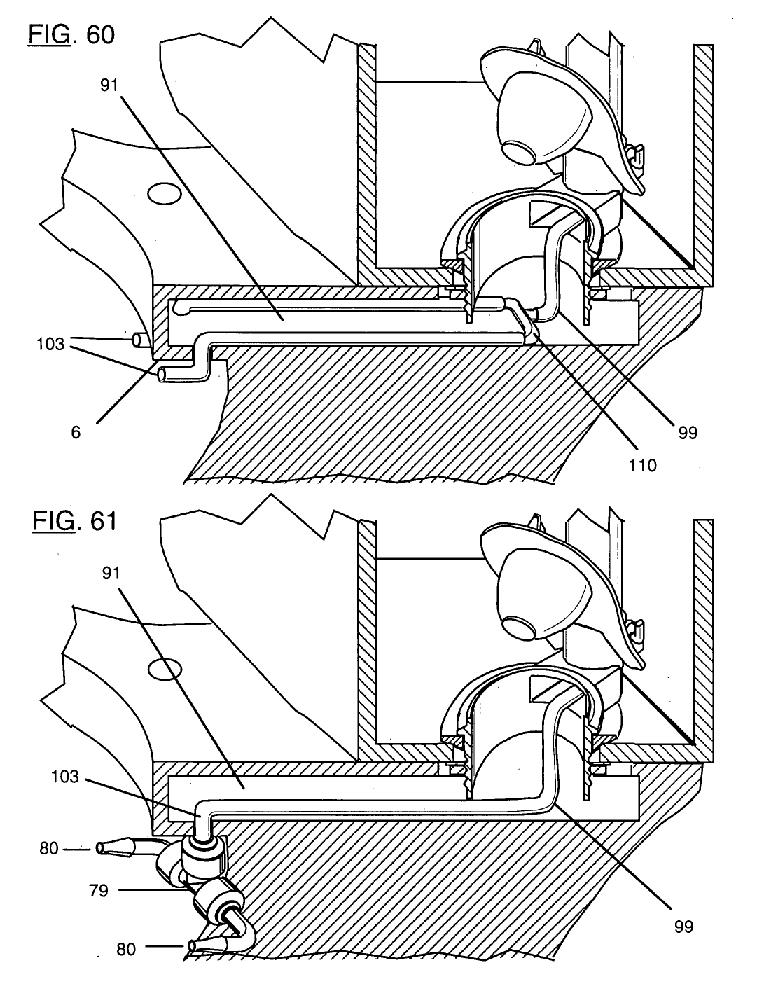

FIG. 60 is a perspective view of a bidet assembly having two “Z” shape tube nozzles 103, which protrude out of two portholes underneath the toilet lip under-surface 6 and whose other ends are connected to two ports of a flexible-tube tee fitting 110, whose third port is connected to the water supply tubing 99.

FIG. 61 is a perspective view of a bidet assembly having two elbow jet nozzles 80 connected to two ports of a tee fitting 79, whose third port is connected to a tube nozzle 103. With this bidet assembly, the two elbow jet nozzles 80 can be individually rotated, about its individual connected port, to adjust the angle of water jet streams.

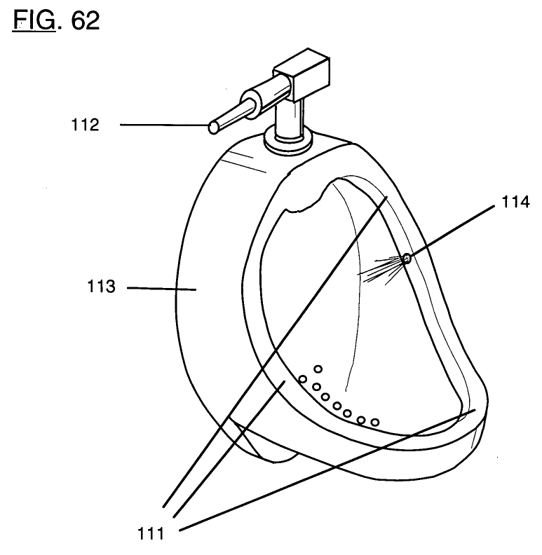

FIG. 62 shows a perspective view of men's urinal 113. Activating the flush activator 112 forces water through the annular cavity inside the urinal surrounding lip 111 and out of holes in the annular channels. The bidet porthole 114 on the side of the urinal lip 111 provides a stream of clean water that men can use for cleansing their penises after urination.

These “bidet toilet combos” obviate any concerns for water-leakage from loosed tube connections. These combos are also more difficult to install on existing toilets than all the previous bidet assemblies of this invention and are probably best made by original toilet manufacturers.

In commercial toilets and urinals where there are no water tanks, the bidet water supply line can be attached to a water source used for flushing the toilet. When it is not possible to connect a water supply line, a bidet porthole (or portholes) on the vertical surfaces of the toilet bowl's or urinal's lip can provide clean water streams for cleansing.

Even in today's totally modern world, users of commercial toilets and urinals have no easy access to water for cleansing their private parts and have to made-do with toilet paper, which does not really do a good job of cleansing but, instead, merely smear out the urine or feces on user's skin. The “bidet toilet combos” of this bidet assembly invention solve these problems and are also less prone to being vandalized and damaged. This is more true for those bidet assemblies wherein all their parts are hidden within the toilet. Commercial establishments that would provide these “bidet toilet combos” may benefit from these advantages:

(1) Provide a special service to their customers,

(2) Customers' satisfaction,

(3) Reduce or completely eliminate clogging of toilets by excessive toilet paper use. Clogging of toilets in commercial establishments is a common and frequent occurrence. It is, not only costly, but also presents a serious hygiene problem for the public, especially when the toilet overflows and flooded the floor, and

(4) Save on toilet paper

Another application for these “bidet toilet combos” is in men's urinals by shooting jet streams of clean water across the urinals for men to use to cleanse their penises after urination. This would be cleaner and eliminate the need for men to “shake” it off. For this application, a suitable name is “bidet urinal combos”.

A further preferred embodiment of this present invention of a bidet assembly is the use of instant (push-to-connect) tube fittings. Watts Company of North Andover, Mass. is one manufacturer of such fittings. Said instant tube fittings provide two advantages: 1. Quick and easy connection between tubing and fitting, 2. Inserted tubing can be rotated within the instant tube fitting and still maintain a water-tight seal. In comparison, compression tube fitting takes time turning a nut to tighten and leaks can develop if nut is not fully tighten.

A still further preferred embodiment of this present invention of a bidet assembly is the use of flexible tube fittings as jet nozzles. The use of flexible-tube fittings as nozzles provides three advantages: 1. Readily available merchandise, 2. The right dimensions, 3. Reduces tube fitting's diameter to a much smaller diameter that gives a finer and discontinuous water stream spray, which gives a warmer sensation even from a rather chilly cold water source. A still further preferred embodiment is barbed flexible tube fittings as jet nozzles. The barb in the flexible tube fittings permit the use of one size smaller flexible tube fitting while maintaining water-tight seal.

### EXAMPLES

Example 1 gives the details of an experiment that determines the minimum length required for a long and stiff member 50 with good % spring-back property to wedge and hold itself in the inside bowl surface 2 and directly below the bowl's lip underside surface 6 and rear corner edge 7. Example 2 gives the details for determining the minimum % spring-back property for a long and stiff member in a toilet bowl. Example 3 gives the details of an experiment that measures the time to install and remove a preferred embodiment in this invention of a bidet assembly.

### Example 1

The dimensions used for an actual sample toilet bowl are: A=17.75″, B=13.5″ (FIG. 5). These are the dimensions for the elliptical shape of a toilet bowl rear lip's corner edge 7. A straight steel threaded rod having size 10-24 and 0.192″ in diameter (made by Steel Works), purchased from Lowe's Home Improvement, was used for this experiment. A 22.6″ length, which is half the calculated-circumference, was used to wedge at the rear end of said bowl (FIG. 18). An equal length from each end of said threaded rod was progressively cut and reinstalled to check for holding power until said rod can no longer stay up on the bowl surface. The results are shown in the following table:

| LENGTH CUT | FINAL | HOLDING ONTO |
|---|---|---|
| FROM EACH END | LENGTH | BOWL SURFACE |
| Start length | 22.6″ | YES |
| 1.0″ | 20.6″ | YES |
| 0.5″ | 19.6″ | YES |
| 0.5″ | 18.6″ | YES |
| 0.5″ | 17.6″ | YES |
| 1.0″ | 15.6″ | YES |
| 1.0″ | 13.6″ | NO |

### The minimum length is calculated taking 13.6″ divided by the circumference of 45.2″ and is equaled to 30.0%.

### Example 2

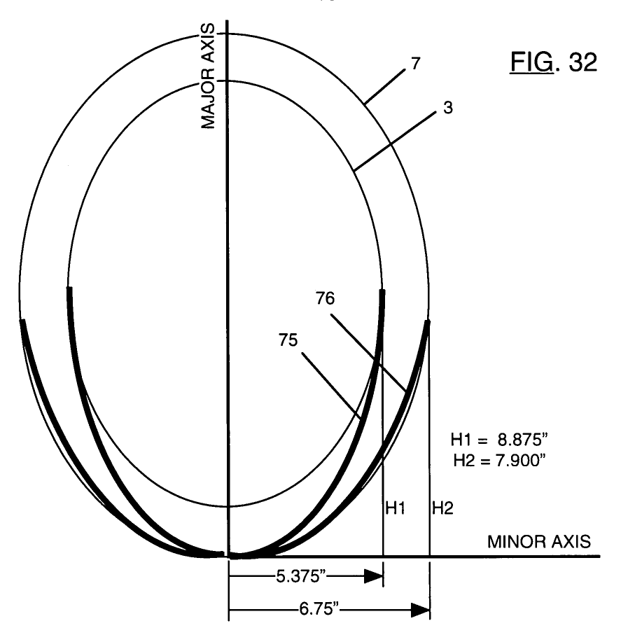

FIG. 32 shows two ellipses representing an actual toilet bowl opening (smaller elliptical shape) and the bowl's lip underside rear corner edge 7 (larger elliptical shape). Said larger elliptical shape of lip's underside rear corner edge 7 obviously can not be seen visibly and is drawn from measured values. In order to insert a long and stiff member into the inside surface of the larger elliptical shape of said bowl, the long and stiff member must first pass through the small bowl opening and this requires minimally bending it as represented by member 75. After passing through the bowl's opening, the ends are released and are restraint by the inside surface represented by the larger ellipse. Said long and stiff member would assume the position of member 76 after its release, assuming that it has enough spring-back property to reach this position represented by H2=7.900″. If the member has higher spring-back property, it would still be restraint but it would have a built-in flex tension, allowing it to press and wedge against the inner bowl surface. If it does not have enough spring-back property, the member would slide down the inner bowl surface. Therefore, the minimum % spring-back is 11.0%, as calculated as follows:

Minimum%Spring-Back=(H1−H2)×100/H1

### Example 3

In this example, the preferred embodiment example of an integral long and slender member bidet assembly of this present invention shown in FIG. 28 was fabricated using only common commercially available tools and merchandise to demonstrate low manufacturing cost. Said bidet assembly was fabricated using: ¼″ OD and 0.218″ ID 304 stainless steel tubing, ¼″ ID and ⅜″ OD PVC (polyvinyl chloride) clear flexible tubing, and quick connect (push-to-connect) ¼″ OD tube “T” fittings (Watts, North Andover, Mass.)

The objectives of quick and easy installation in this present invention of a bidet assembly is demonstrated by timing the speed to install and to remove said fabricated bidet assembly from a toilet. A total of five trials of installation and removal were done. It is assumed that a user would first read an installation instruction prior to actual installation. Therefore, the recorded time is the actual time to install and remove, not counting the time to read the instruction.

Said fabricated bidet assembly comprises six parts: B3—the two jointed “T” fittings with nozzle 63 and short water supply tube 67 already attached, arms 61 and 62, inverted rigid “U” tube 37, flexible tubes 36 and 38. The installation time also includes time to join said parts together plus removing and replacing a toilet tank cover. The result of five trials is shown in the following table.

| | TRIAL NO. | | | | | |
|---|---|---|---|---|---|---|
| | 1 | 2 | 3 | 4 | 5 | AVERAGE |
| INSTALLATION | 1′9″ | 1′19″ | 1′9″ | 1′ | 1′15″ | 1′10″ |
| TIME (Minutes) | | | | | | |
| REMOVAL TIME | 39″ | 52″ | 36″ | 44″ | 46″ | 43″ |
| (Seconds) | | | | | | |

The average time for installation is less 1.5 minutes and for removal, less than a minute. These amazing results conclusively prove that this present invention of a bidet assembly is quick and easy to install and remove.

What is claimed:

1. A bidet assembly comprising
a tube nozzle, one end inside a porthole through the toilet bowl's lip, and whose other end is connected to one end of
a water supply tube, whose other end passes through the water flushing channel inside the annular space of the toilet's lip and is connected to a water supply source.

2. The bidet assembly of claim 1 wherein said porthole location is selected from the group consisting of
the vertical surface of a toilet bowl's lip and
the underside surface of a toilet bowl's lip

3. The bidet assembly of claim 2 wherein the location of the portholes is at the rear of the toilet bowl.

4. The bidet assembly of claim 1 wherein there are at least two water jet streams provided by the following means selected from the group consisting of
tube nozzles connected to all available ports of a fitting with at least 3 ports with one port connected to said water supply tube, and
a fitting with at least three ports, with one port connected to one end of said tube nozzle and each available port is connected to an elbow jet nozzle. The other end of said tube nozzle is connected to one end of said water supply tube.

5. The bidet assembly of claim 1 wherein said water supply tube is threaded through the toilet bowl rear flushing channel, inside the flush valve assembly, up and out the top of the overflow tube and finally connects to a water supply source.

6. The bidet assembly of claim 5 wherein said porthole location is selected from the group consisting of
the vertical surface of a toilet bowl's lip and
the underside surface of a toilet bowl's lip

7. The bidet assembly of claim 6 wherein the location of the portholes is at the rear of the toilet bowl.

8. The bidet assembly of claim 5 wherein there are at least two water jet streams provided by the following means selected from the group consisting of
tube nozzles connected to all available ports of a fitting with at least 3 ports with one port connected to said water supply tube, and
a fitting with at least three ports, with one port connected to one end of said tube nozzle and each available port is connected to an elbow jet nozzle. The other end of said tube nozzle is connected to one end of said water supply tube.

9. The bidet assembly of claim 5 wherein the water supply source is the toilet bowl refilling nipple.

10. The bidet assembly of claim 9 wherein said porthole location is selected from the group consisting of the vertical surface of a toilet bowl's lip and the underside surface of a toilet bowl's lip

11. The bidet assembly of claim 10 wherein the location of the portholes is at the rear of the toilet bowl.

12. The bidet assembly of claim 9 wherein there are at least two water jet streams provided by the following means selected from the group consisting of
tube nozzles connected to all available ports of a fitting with at least 3 ports with one port connected to said water supply tube, and
a fitting with at least three ports, with one port connected to one end of said tube nozzle and each available port is connected to an elbow jet nozzle. The other end of said tube nozzle is connected to one end of said water supply tube.

13. A bidet assembly comprising of
a tube nozzle, one end inside a porthole in a toilet bowl's lip, and whose other end is connected to one end of
a water supply tube, whose other end passes through the toilet bowl water flushing channel inside the annular space of the toilet's lip, through the bowl rear flushing channel, runs up inside the flush valve assembly and comes out the top of the overflow tube and finally connects to the toilet bowl refilling nipple.

14. The bidet assembly of claim 13 wherein said porthole location is selected from the group consisting of
the vertical surface of a toilet bowl's lip and
the underside surface of a toilet bowl's lip

15. The bidet assembly of claim 14 wherein the location of the portholes is at the rear of the toilet bowl.

16. The bidet assembly of claim 13 wherein there are at least two water jet streams provided by the following means selected from the group consisting of
tube nozzles connected to all available ports of a fitting with at least 3 ports with one port connected to said water supply tube, and
a fitting with at least three ports, with one port connected to one end of said tube nozzle and each available port is connected to an elbow jet nozzle. The other end of said tube nozzle is connected to one end of said water supply tube.

17. A bidet toilet comprising of a toilet with bidet portholes, opened to the water flushing channels of the annular cavity in the toilet bowl lip, on the vertical surface of the toilet bowl's lip.

18. A bidet urinal comprising of men's urinal with bidet portholes, opened to the water flushing channels of the annular cavity in the urinal surrounding lip, on the inside surface of the urinal surrounding lip.
